(19) United States
(12) Patent Application Publication
(10) Pub. No.: US 2005/0021523 A1
(43) Pub. Date: Jan. 27, 2005

(54) Holistic dynamic information management platform for end-users to interact with and share all information categories, including data, functions, and results, in a collaborative secure venue

(76) Inventor: Wafik Farag, Cambridge, MA (US)

Correspondence Address: WAFIK FARAG, Apt# 405, 2456 Mass ave., Cambridge, MA, 02140, US

(21) Appl. No.: 10/338,932

(22) Filed: Jan. 8, 2003

Related U.S. Application Data
(60) Provisional application No. 60/346,376, filed on Jan. 8, 2002.

(51) Int. Cl. G06F 17/00

(52) U.S. Cl. 707/100

(57) ABSTRACT

A method, apparatus, and article of manufacture consistent with the present invention provide a development tool that enables end-users or automated systems to independently or collaboratively develop and manage all information item types as stored in the different categories to dynamically manipulate them across internal information categories or items from external sources in a networked environment. Manipulate enables users to securely on-the fly do activities best described as: to access, create, store, delete, modify, discover, collaborate, integrate, execute, re-run, track, limit-access-to, and share of information items. Information items of same type, for example, data items, are grouped together in a category for system management purposes, i.e. DBMS. However, all information categories are easily accessible to be linked together. The tool provides an integrity engine with modifiable rules to best suite the policies and procedures on how information items are manipulated by users as mandated by the entity managing the tool.

Applicant hereby claims the benefit of priority of Provisional Patent Application No. 60/346,376 filed on Jan. 8, 2002, herein incorporated by reference.

### BACKGROUND AND SUMMARY OF THE INVENTION

This invention relates generally to the field of information management targeting non-technical end-users to dynamically, collaboratively and securely manage relations on-the-fly (i.e. dynamically manipulate without a priori design knowledge) across all information items, and more particularly, to manage data and functions internally and from external sources to obtain results which are user managed as well.

In an information system, two categories are widely mentioned, data and information and sometimes the distinction is blurred. In this invention, information encompasses data as one of its categories in the information spectrum. Information categories are best described to include data, functions (+stored queries), and results. The term category is used to identify a group of information items requiring a distinct way of handling as how they are stored, accessed and retrieved. The data category plays a major role affecting the whole information spectrum which is conventionally known as database management systems (DBMS) as discussed next.

Data Category:

DBMS were designed to satisfy the storage and retrieval needs of large static software system. DBMS have been extremely successful in sustaining the demands of large stable corporate entities that required little change over time. However, in a dynamic environment, like biotechnology, where the main activity is research for finding new relations among different organisms and compounds mandates to quickly capture new results that link existing with newly found or introduced attributes, in which case a DBMS quickly breaks down.

Three main obstacles that best describe such breakdown are as follows:
1. The fact that existing DBMS are static consumes time and expensive resources to reflect a change. A dynamic DBMS is needed allowing end-users to create new attributes and capture new relations on-the-fly.
2. A shift in type of user directly accessing the database is needed. Database administrators (DBAs) guarded their systems very closely preventing any access. This was essential when systems are used, for example, in call centers with users' level of sophistication and the type of data at hand are different. In the example of the biotech research, the end-user is a scientist of an experienced caliber and the type of data is sometimes owned by that same scientist who guards it with a degree of vigilance maybe higher than a DBA.
3. Collaboration becomes essential in dynamic systems. The traditional database life cycle of requirement gathering by a team, schema design, than passing the flow to a few DBAs breaks down because of limiting sophisticated end-users from directly contributing to the system over time and keeping the system up to date. With collaboration, a tracking system of who did what when and a set of policies and procedures protecting and facilitating users interacting in such a community becomes essential.

The above three obstacles stem mainly from existing DBMS static approach to change. Examples of most widely used models are relational and object oriented. These obstacles will be clearer as to why they exist after discussing the short comings of both models.

Conventional DBMS:

Conventional relational DBMS, the most widely used data model, is based on lambda calculus. It tightly fixes the relation between attributes, data elements signifying a group of values like phone_numbers, to their relations. For example, a relation, represented as a table with a group of attributes, called “Customer” has attributes: name, address, and phone #. This is represented in the data dictionary, a master lookup table used by the relational model to parse and execute SQL queries, as an entry like “Customer: name, address -> phone #” which means a phone # is dependant on name and address in relation/table “Customer” and that the attributes name, address, and phone # reside in relation Customer. In the data dictionary, each table has one entry with the table name as the key attribute for search together with all the functional dependencies within that table. A user cannot get a person's phone # if they only know their name. In the relational model, the interface language available to programmers, i.e. technical users, is SQL. A user executes an SQL query, like: “Select phone # from Customer where name=Matt” to get Matt's phone number out of the relational model. If the user does not know the table name “Customer” and that attributes name and phone # belong to the Customer table, the user will not be able to retrieve a person's phone number, as in the relational model. The user is required to have a priori knowledge of the underlying schema in order to use the DBMS. The schema identifies the relations between attributes and tables and the dependencies among attributes. This is what makes relational models rigid because attributes are fixed to a relationship once a schema is designed.

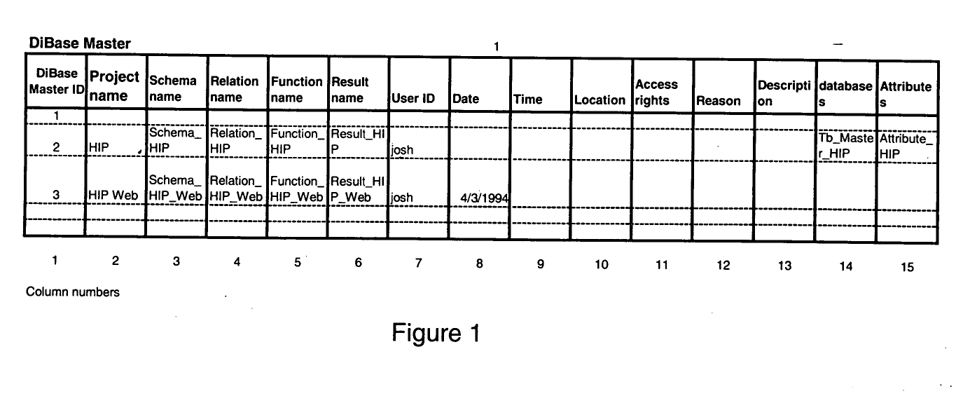

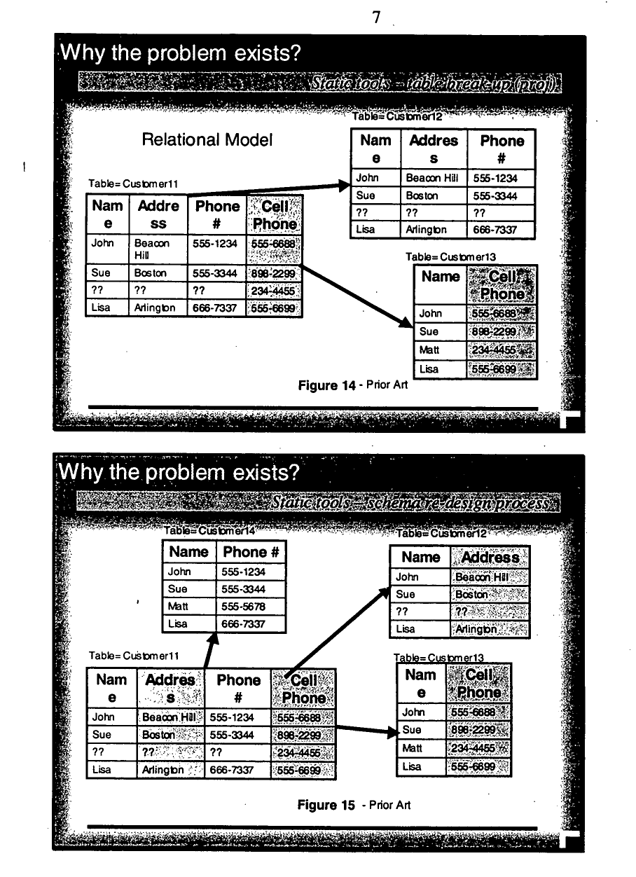

The above design limitation of fixing attributes to relations in a relational model explains its ruggedness to change relationships on-the-fly. Let us assume customer now has a cell phone number and a DBA adds it to table Customer as a quick work around to avoid schema redesign (see FIG. 1 fourth column in table customer). Let's say customer Matt moves (See FIG. 13). Due to the delete anomalies, the customer cell phone number data will be lost since the functional dependency of table Customer in the data dictionary looked like: “Customer: name, address -> phone #, cell phone” which renders the cell phone dependent on the name and address. To avoid losing the cell phone number information, the user needs to split the Customer table into two tables, say Customer12 and Customer13 (See FIG. 14), which triggers a complete schema redesign cycle (see FIG. 17). Similarly, if phone is found to depend only on name and not address, a similar split will be needed (See FIG. 15) to preserve the functional dependencies as name -> phone # and name -> address. This ruggedness to change can have major business impact due to time delay and expenses incurred. For example, when the FCC issued that customers can keep their phone number irrespective of the phone company allowing users to take their phone numbers wherever they move implies that phone# depends on name and not address triggers a databases re-design.

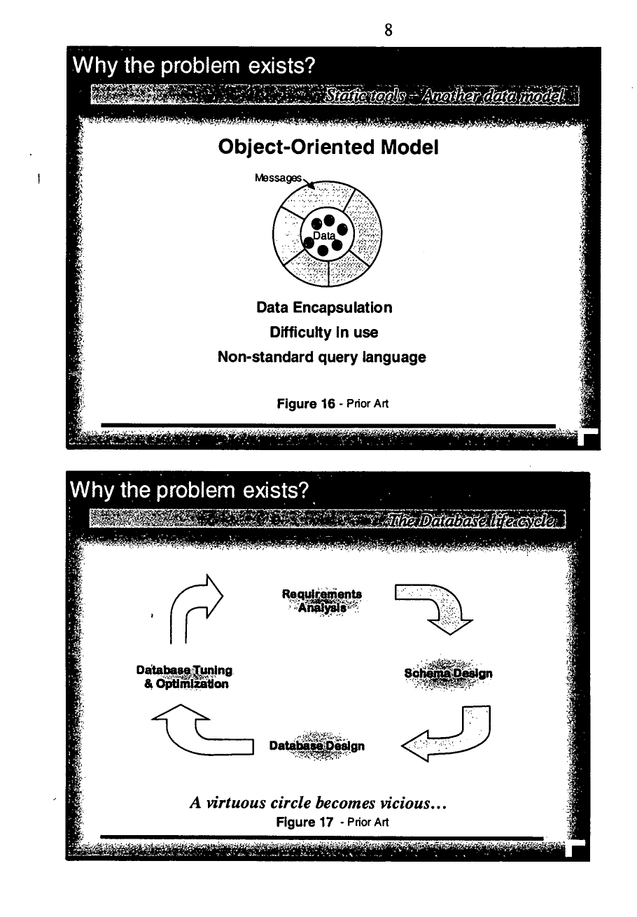

Other database models, like object-oriented database have similar limitations. In FIG. 16, the object model encapsulates data elements by methods. The relationships and logic of the encapsulated data elements are locked in the encapsulating methods. A change mandates a change in the method and the messages related to accessing that method will need to change as well rendering the model also rigid to dynamic change requiring a system redesign. Object-oriented suffer from two other main obstacles: data encapsulation makes it harder for an end user to access the data without knowing the method to use, that is requires a priori knowledge of the system, that is what is the name of the method and how to instantiate it. Secondly, no standard query language which gained the relational model a popularity in the market share due to the ease of use and standard operators available in the SQL language.

Type of User: Both models suffer from limiting their user community to highly technical users to interact with the DBMS such as DBAs or programs. Programmers embed statements to query or insert data in the function code they write allowing the function to interact with the underlying DBMS. Written functions shield end users from the details or the need of apriori knowledge of the underlying data model. This eliminates access for an end user to interact with a conventional DBMS.

Collaboration: From the previous point, type of users allowed to interact with DBMS is limited to only highly technical staff. This shuts access for end-user collaboration. Thus other technical requirements like tracking or policies and procedures for different users are not discussed in existing DBMS.

Information Categories:

Beyond data, the two most best know categories are functions and results. Other categories exist like stored queries, storing SQL statements, that is, information categories are not only limited to data, function, stored queries, and results. The difference between stored queries and functions is important as a category, the way a group of items are stored, retrieved, and manipulated, see function category for discussion. However, functions, stored queries, and results are best referred to as software systems, like applications.

Software Systems

A software system is best described as a: data layer where data is stored in a conventional database management system (DBMS); a functionality layer where a group of functions are stored in a file system or a functionality server to be instantiated by a user via the interface layer; and an interface, i.e result or rendering layer, which manages the input and output of the system to the User. Each layer responds to requests interfacing with the underlying layer forming a software system.

In flexibility of software systems is best described as:
1. Interactions are one-way: Users request or insert data according to a predefined slot or functionality. For example, a user in a car repair shop notices that the color of the car does relate to the repair intervals of certain parts. Let's say red car drivers can be more aggressive resulting in more frequent tire and bake repairs. Adding attribute “color” to relations in a conventional system by an end user is not possible. It requires technical expertise and might trigger a schema re-design. This results into an impact on the DBMS, on the functionality server and the interface to accommodate the new requirement. That is what is meant by “one-way”, i.e. using the system as designed inserting or requesting data values based on some operation out of the system, not possible to add or change new requirements into the system. In case a result creates a new attribute, the result can not be stored back into the system—i.e. on-way.
2. Closed function-base: Inserting new functionality requires technical expertise to add and link them to the underlying DBMS, i.e. create the relation between the function and what attributes/tables it needs to access. Even if the software system exposes the function base, i.e. available functions, to the user empowering them to choose the sequence of execution by building a workflow or a data-flow-path (DFP), the pool of available functions is still closed. The system suffers from its inability to allow end-user to add new functions to the pool because making the link to the underlying DMBS requires knowledge of the underlying design of attributes and relationships.
3. User interaction: end-user interaction is limited to the interface as requested by the business needs and developed by a technical team. The end-user doesn't have control to make a change and depends on technical resources. System updates translates into a painful process with time delays for updates plus the expense to carry out.

The biggest obstacle in a software system becomes its static DBMS that captures the business requirements of the system regarding relationships among attributes and tables are stored. Because of the static nature, software systems are built in a “silo” fashion. A change in the DMBS doesn't trigger which functions are affected—no relationship exists—the programmers who insert the data access statements in the function code assume static state of the system and any schema re-design includes re-visiting and manually examining the function-base as well—i.e. “system silo effect”. Similarly with results, an obtained result doesn't keep track of the DFP used or data sources used.

Similarly interface layers are best known to be data-driven or static. For example, a web-based system using dynamic data driven web layout is driven by a function that is based on the underlying static data model. The dynamic aspect of the interface is based on the permutations and combinations of the fixed pool of attributes whose data values trigger conditions causing a change in the web-state. This is different than in a dynamic data model, where new attributes get added to the mix of available attributes affecting the conditions to be triggered causing the web change. Changing the interface behavior needs an update in the driving function(s) and updates to the data-model statements requiring a priori knowledge expected by a technical user. That is, the static DBMS remains the obstacle for a true dynamic change based on new attributes versus data values.

System silo hinders end-users ability to add new features or change system behavior.

Function Category

Advancements in function-bases, that is, a category where functions can be stored, selected accessed, arranged for execution in a DFP manner, enabled end users to gain more independence control in achieving results in record times. A key obstacle remains is the ability for end-users to introduce new functionality. As discussed above in the software system limitations, adding new functionality or modifying existing functionality that require or reflect a change in the underlying data model remains a stumbling block to end-users. It requires technical assistance resources to interfere. Hence, existing function-bases are static. The capability of a user checking in a function is lacking.

This limitation translates to a number of areas:
1. Collaboration: end-users can't share functions which encapsulate experience or complex logic instrumental in obtaining certain results—no function check-in capability.
2. Data integration: A function operates on data sources and its logic results in linking those sources creating a relation among them. This is key in advancement of data integration is to enable researches and end-users to contribute to large data integration efforts. Still, without the ability to check-in functions, new relations are missed and have to wait next system update.
   Result Category

Results suffer similar symptoms like functions. Prior art in capturing how results are obtained by which set of functions and data sources used cannot be stored back into a database if the result introduces new attributes or new relations. For example, a merchant identify their customers via their phone numbers. One customer requests to add the cell phone number as an alternate number. If the database doesn't have an attribute or a slot of an alternate or cell phone number, the merchant is stuck with a rigid system—a common experience. Hence results that do require a DBMS change are stuck. This results into short coming in collaboration and sharing of results, discovery of how new results where obtained and what DFP used, discovery and information access of finding how new data sources or functions used in obtaining a result.

Data Integration:

Due to the importance of this topic—data integration—unraveling the root symptom is important and relevant to this invention as the tool under discussion solves root cause.

Data integration across multiple sources is a manual activity of capturing a relation between two or more items and doing this still remains a challenge! The key bottleneck remains the “staticness” of the tools and the approach to the problem.

Three obstacles that best describe the problem are:

The approach: Most integration efforts tackle the process by assigning a limited number of experts (i.e. “Group”) to integrate a number of underlying data sources. The group creates a parser-like engine or identifies relationships in a schema design like exercise. The outcome is a virtual integration layer providing a unified view for the end user. By the time the integration process is complete; two reasons already limit the effectiveness of the solution developed by the Group. First, each underlying data source continues to change. Second, other experts outside the Group continue to find new integration relationships. Hence, the Group is forced to undertake another effort of data integration. This iterative approach to integration fails to take into account the on going changes that take place while the integration process is in progress. By the time the process is complete, it is already obsolete!!

The time spent creating a virtual integrating layer becomes the bottleneck during which no external integration rules or changes in underlying data sources are considered. Everything is put on hold until the next integration cycle.
1. The Tools: Current data modeling technologies, which are the tools used to solve integration problems, are static. Adding a new relation triggers a schema re-design in the relational model and a similar effect takes place in the object oriented model. On top of that, the parser engine-like approach which acts as the virtual integration layer locks in the logic linking data items from underlying data sources rendering it static as well. This creates a compound stagnant effect, as it not only locks the logic in the parser; it also mandates that the underlying data sources must remain static as well. This multifaceted “staticness” of current integration approaches, i.e. static virtual integration layer depends on static underlying data sources—renders a fragile and inflexible solution.
2. The Expertise: The process of schema redesign mandates a restricted number of participants. During an exercise to update a schema, expertise is restricted to only a few available participants who have expert knowledge of the field and the data modeling tools. Similarly, the process of creating a virtual integration layer is limited by a small number of participating experts to produce a single snapshot. This static design methodology captures the experience of a few at a point in time, rather than providing a model that can incorporate perspectives from many experts continually over time—the collaborative effect.
Data integration is an on-going-process, particularly if it targets integrating highly dynamic and varied disciplines like chemical, genomic, proteomic, biological, etc. which require the collaboration of many experts from different fields over time instead of a few for a limited time.
3. The Logic: Integrating data items is based on logic to relate those items together. The relating logic varies depending on some similarity factor like complexity or dimensionality. In dimensionality, like data items that share in space, in time, or in an experiment . . . etc? In complexity, data items share similarity resulting from a search, say a Blast search (a function that matches, identifying a relation, the input of a gene sub-string to which gene in the human map), or after running a data mining function which is the result of a more complex function. Such similarity can be based on one or a series of functions leading to the complex logic. Separating the integration logic is key for users to understand the rationale behind why a similarity exist and for allowing users to change or test the correctness of the logic keeping the model agile to change if needed? With the logic being connected to the data items while maintained in a separate layer enables users to contribute to the virtual integration layer with more clarity as to why a relationship exist allowing more experts to participate.

Data integration (DI) is an example that highlights the severity of the problem at hand. The user of static tool across all information categories limit the ability on how to identify or tackle a solution. A large number of discipline that need to deal with legacy data face data integration and data access issues, biotechnology is just one example. Using dynamic information category tools together with end-user access to enable collaboration efforts leads to dynamic data integration (DDI)—will identify as the true data integration approach.

The growths of dynamic disciplines, like biotech as an example, have caused a demand for dynamic information management to rise sharply. Dynamic information management poses at best three main challenges:
1. Dynamic information models to deal with continuous change. Information
2. End-user access leading to collaboration, information discovery and new ways of information access
3. An integrity engine to maintain policies and procedures as well as a tracking mechanism.

### DETAILED DESCRIPTION

To better understand the subtlety of the invention, let's discuss basic concepts. Our understanding of information versus data is important: a data item becomes information when put in a context for a need. For example a traveler asks an airline ticket agent: “When is the next flight to Dallas?” The airline agent answers “5:25”. To clarify, 5:25 becomes information and not data because it was used in a context satisfying a need requiring no more processing. Here, the context is a set of variables (i.e. attributes) like:
Start location as airport terminal or gate
Time of day—morning or afternoon, etc.
Airline carrier
Routing method—direct non-stop.

Such context was assumed by both parties, the traveler and the airline agent, during their interaction.

Every attributes in a context plays a role in affecting other attributes and the result obtained. An attribute adds a dimension to the context space. In the ticking example, attributes carrier and routing method can limit the outcome significantly. To design a model to operate and manage information items, the context is best thought of as the model to represent different information categories.

Contextual model allows change to take place over an attribute dimension. For example, let's take a room in an office. The space attribute identifies the boundaries of the room as the limits of the context for that attribute. A time attribute start time is another limit. An attribute for employees adds a type to exist within the context, such as the people that come and go. In a data model, the contextual data model is different than traditional data models, say relational, in that a schema capture a snapshot in time the relationships among a group of attributes. Once a schema is design—relationships are fixed! Also, a context allows many users to change. In a room, different people and move different object independently or collaboratively. The constraints of in the room can be set by the group in place or maybe and outside entity that owns the room. This is a significant difference over static models.

Contextual Database Model

Contextual database model is a database model for storing, retrieving, and manipulating of data, modifying of relations, and managing the co-existence of multiple schemas.

In the background section two main limitations were identified in the relational model:
1. The need to know the table name in order to put or get any data value out of DBMS.
2. A database schema change mandates a complete database schema redesign of the four main steps as shown in FIG. 17.

The basic notion to overcome shortcomings of a static DBMS is to make access to data independent from relations. This allows a user to interact with the system in a manner closer to real life. For example, a user seeking a phone number expects having the persons name is sufficient to get the phone number, only in the real world where context exists. In a conventional DMBS examining posing the question using SQL one needs to fullfill:
Select <what you need to get> from <within a specific table> where <this is what I know>.

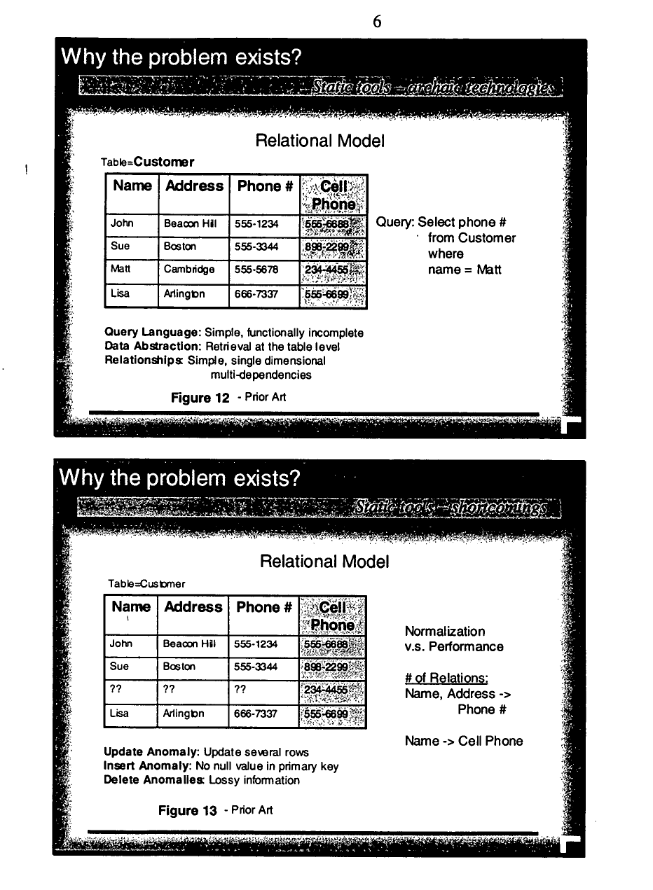

This instantiates the query to be as in FIG. 12: Select phone# from Customer where name=Matt. How would this convert to the contextual model? Let's assume that table Customer in FIG. 12 is part of a schema of a telecom's database. An end-user would call an operator in a telecom company and ask for Matt's phone number without the need to have a priori knowledge of where such information is stored. This is the need of separating the data from the relations. Once data is separated and placed within a context, end-users will be able access data values without the need of a priori knowledge of the storage structure. By calling an operator in the telecom company, the user instantiated the context as the operator replaces the table need and provides the phone number given a name.

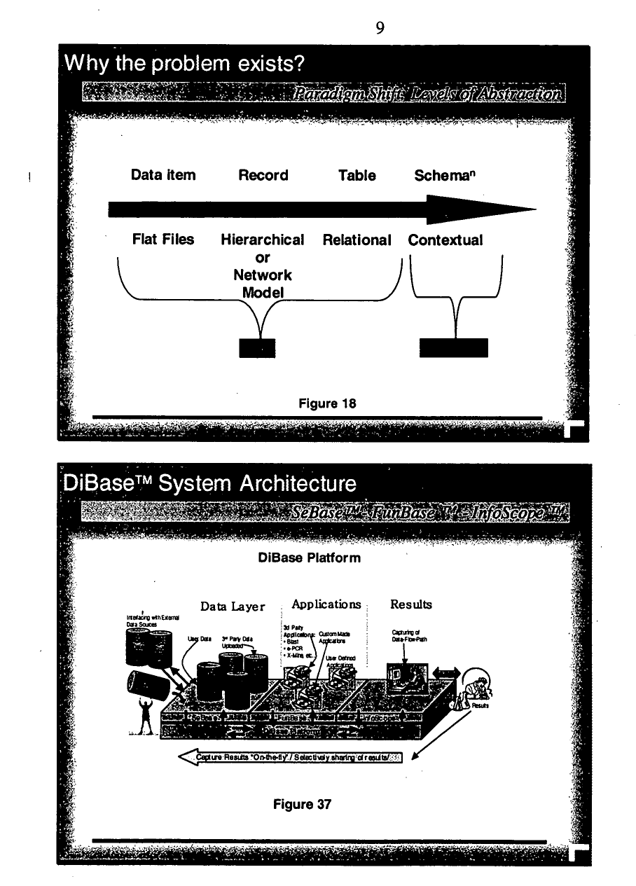

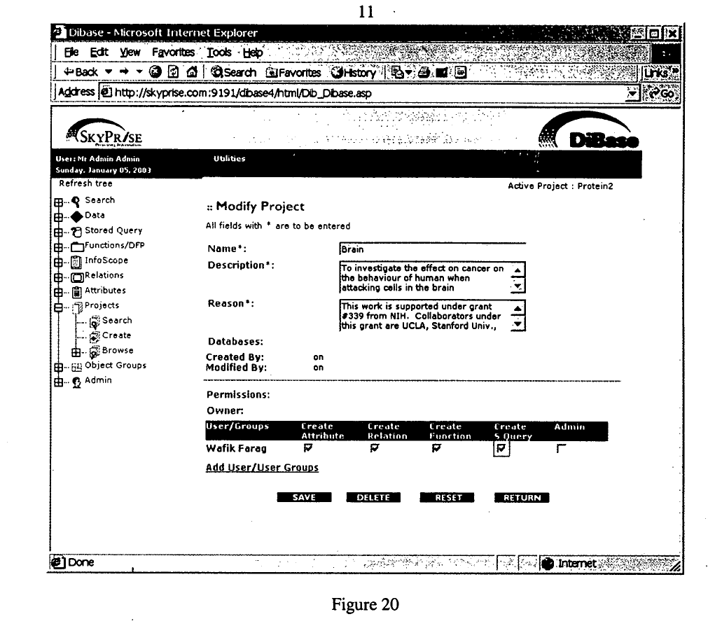

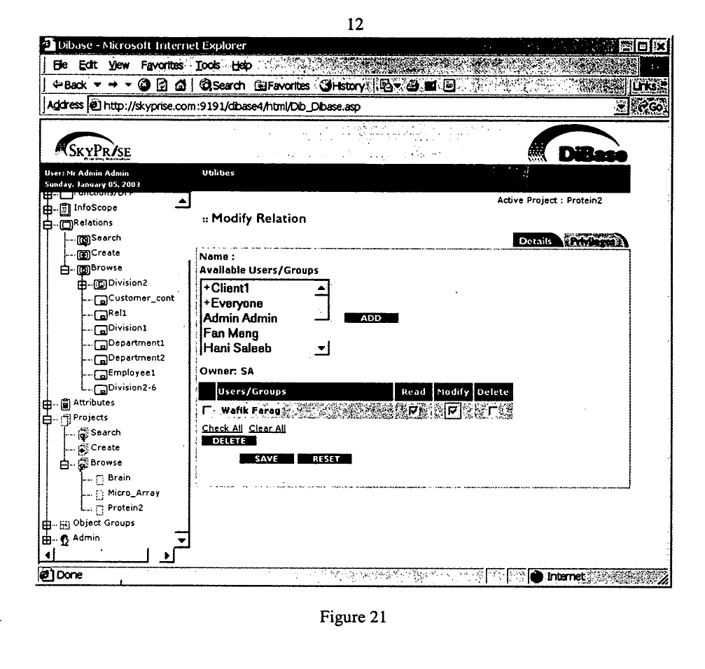

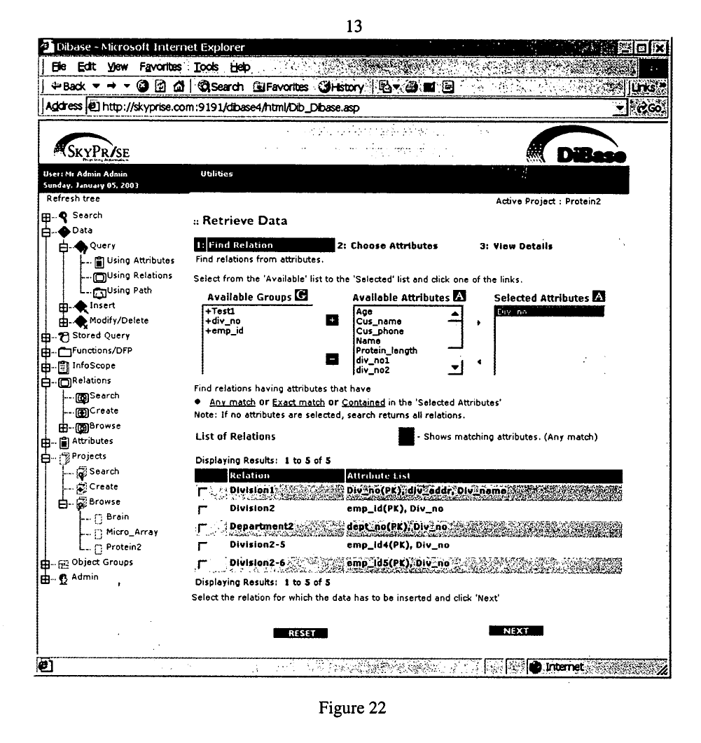

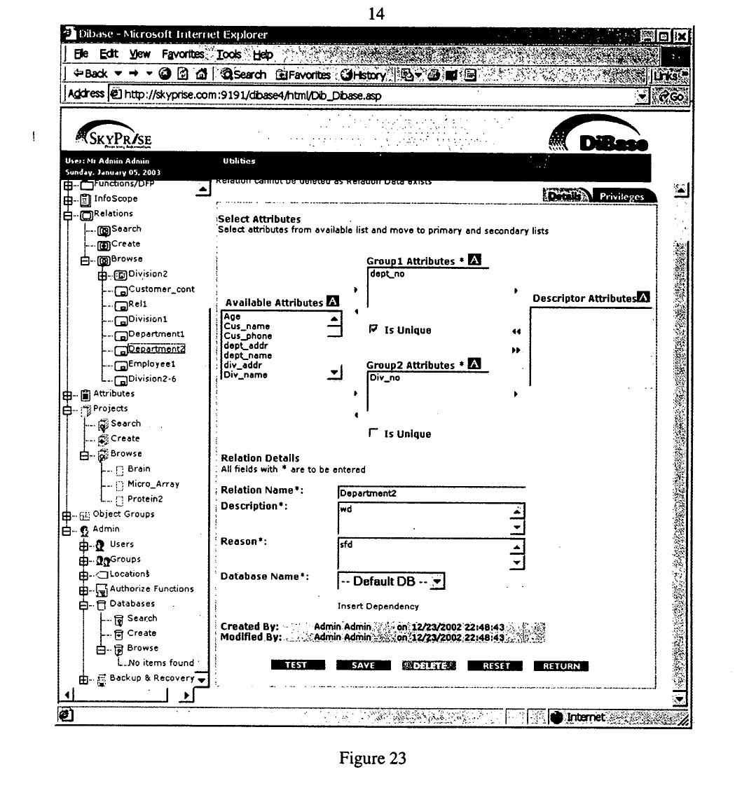

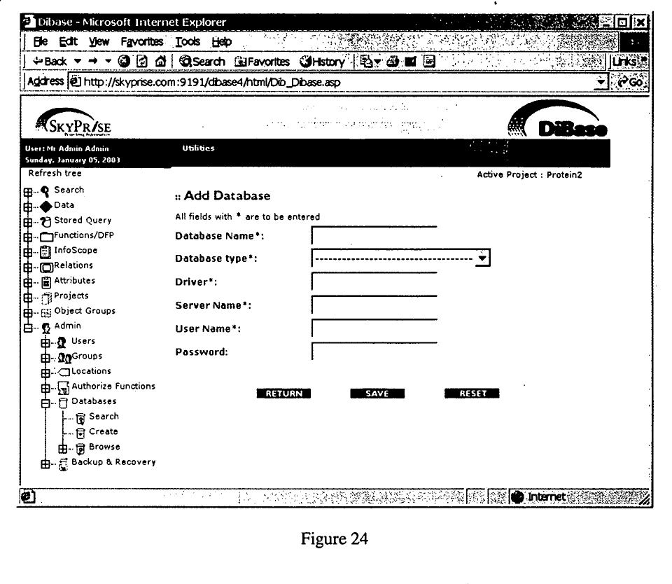

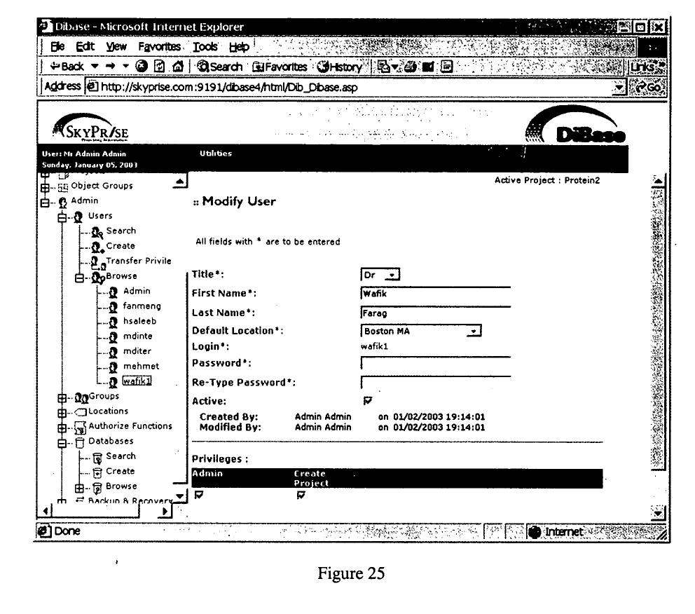

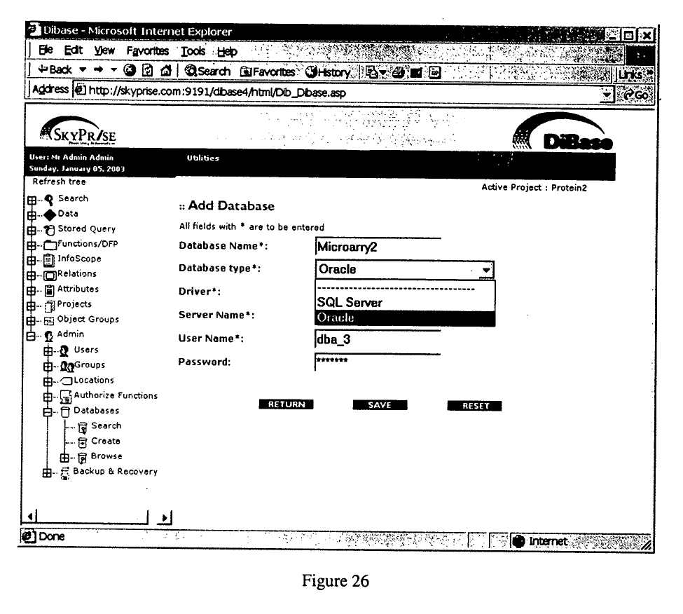

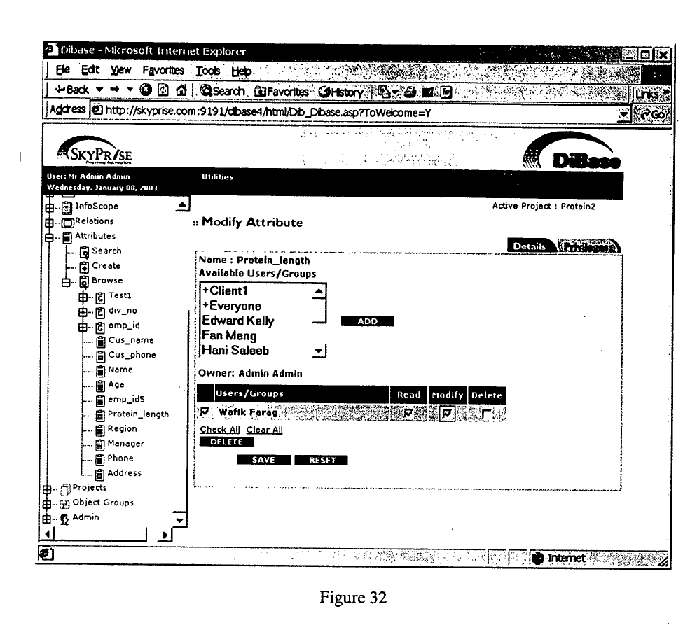

This invention brings a major change in how data storage and access is conducted. In FIG. 18, we see the progression of the different data models below the arrow and data structure needed to manipulate data above the arrow. In the hierarchical model, the actual hardware location of the record was need. In the relational model, the exact name of the table containing the attributes is needed. In the contextual model, a user needs to know the context, which has a structure will call schemaⁿ, in which data is stored. A schema^{N} is the collection of all contexts, that is schemaⁿs, within a system. schema^{N} is quite different from our current understanding of what a schema is in a relational model in the following aspects:

| Schema^{N} | Schema |
|---|---|
| Dynamically changes over time via user | Is static, any change will require a schema |
| input. Keeps up with the change in business | redesign. Captures a snapshot in time |
| requirements allowing different views to co- | representation of a business requirement. |
| exist in sub-schemaⁿs. | |
| End-users in different geographic locations at | Change process: Is controlled by a few |
| different time intervals, as permitted by | usually in the same proximity and all change |
| security and access rights, can change the | requests must be funneled through technical |
| schemaⁿs | experts. |
| Multiple schemaⁿs can co-exist at the same | Only one schema is accessible at any point in |
| time within schema^{N} and context to be | time. The user has no choice. |
| selected by the user. | |
| Tables within a schema^{N} or schemaⁿ are | A schema can exist on one hardware |
| loosely coupled and can exist over multiple | configuration. For a schema to exist on more |
| hardware boxed permitting scalability. For | than one hardware configuration, extensions |
| performance reasons, administrators move | to the data model like segmentation and |
| tables or parts of large tables to other | distributed methodologies need to be applied |
| hardware configurations transparently from | which are time consuming and require design |
| the user to reduce data throughput thrashing | and setup time. Connecting external DB is |
| increasing performance. See FIG. 23, a | not feasible; a total integration effort is |
| user, with correct permission, selects to store | required. |
| relations on different boxes (identified as DB | |
| for user simplicity) from a drop down menu. | |
| In FIG. 24, an administrator adds a new DB | |
| to the system to quickly expand and scale the | |
| system dynamically. A DBA can also | |
| connect an external conventional DB, see | |
| FIG. 26 as a new context. | |
| Users can discover relations and new | User must have a priori knowledge of the |
| attributes by selection an attribute or more of | schema to access data. The interfacing query |
| interest and request the list of relations that | language does not allow navigation or |
| match exactly, any match, or partial match, | discovery of the underlying schema. A user |
| see FIG. 22. | cannot query: “List all relations that contain |
| | the attribute “x”?” |
| In a collaborative environment, it is important | Usually and an administrator needs to create |
| to allow users to enforce policies and | a view (a collection of tables) in the relational |
| procedures on their work of art. From the | model to restrict access to certain users. |
| attribute up to the context level, users can | Users can't restrict or assign access rights on |
| assign access rights of various degrees, see | their own work on-the-fly. |
| FIG. 32 for attributes, FIG. 20 for projects, | |
| and FIG. 21 for relations. | |
| In a collaborative dynamic environment, it | Users must have complete understanding of |
| becomes critical to have meta-data about | the data model prior to usage. No room to |
| every element in the data model. See FIG. | add or view comments, let alone increment |
| 19 for an attribute as an example. Fields like | them. All users of the system require training |
| description and reason are provided to the | and understanding of the system. |
| users to add and increment comments. The | |
| system time stamps every comment and | |
| keeps them in a journal log like manner. | |
| Policies and procedures can be enforced on | Users don't have access to a DBMS, only |
| user access pending given rights, see FIG. | DBA's. |
| 20 as an example for user rights at the project | |
| level. | |

Hence, schemaⁿ elevates the user from the table level to a contextual level reducing one more level of design level information needed for input. With schemaⁿ, a user can have more than one schemaⁿ at the same time.

For example, users within a certain context like in a telecommunication company and work in customer service, or operation, or accounting can have the different schemaⁿ one for corporate billing another for switching systems and communication network. Users who have more than one role will have the right to access the needed schemaⁿ's existing within a single software system yet maintaining separate boundaries, i.e. contexts. This allows different conflicting view to co-exist in different schemaⁿ while integration between different parts takes place.

In FIG. 18, the contextual model removes the user from the table level to a schemaⁿ level unlocking the scope from table level in relational databases to schemaⁿ level in the contextual model where all attributes are available. With this, the contextual model separates data from relation placing the system at an information level and not at a data level. This allows the data model to be dynamic; users can insert new attributes and relation on-the-fly.

How it Works

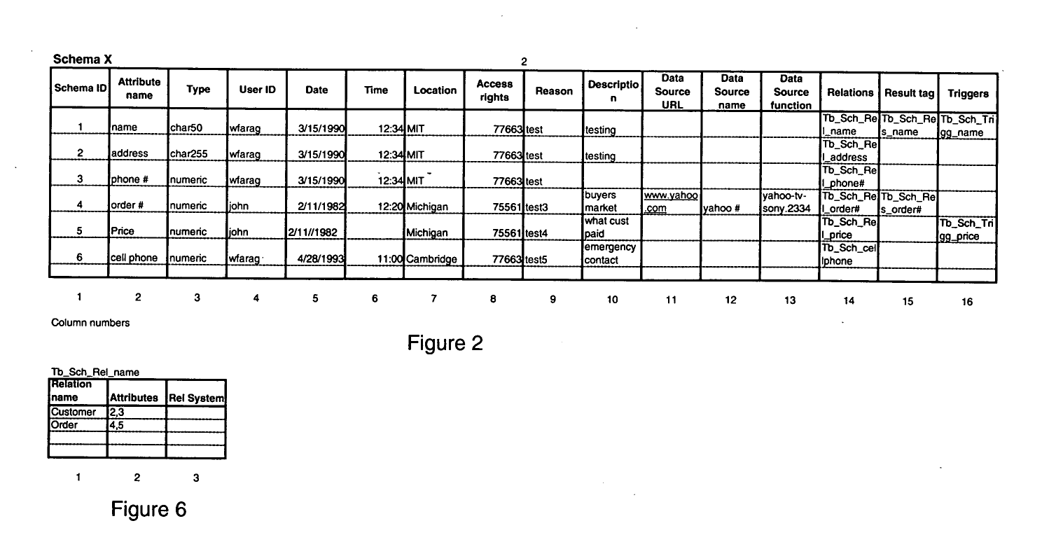

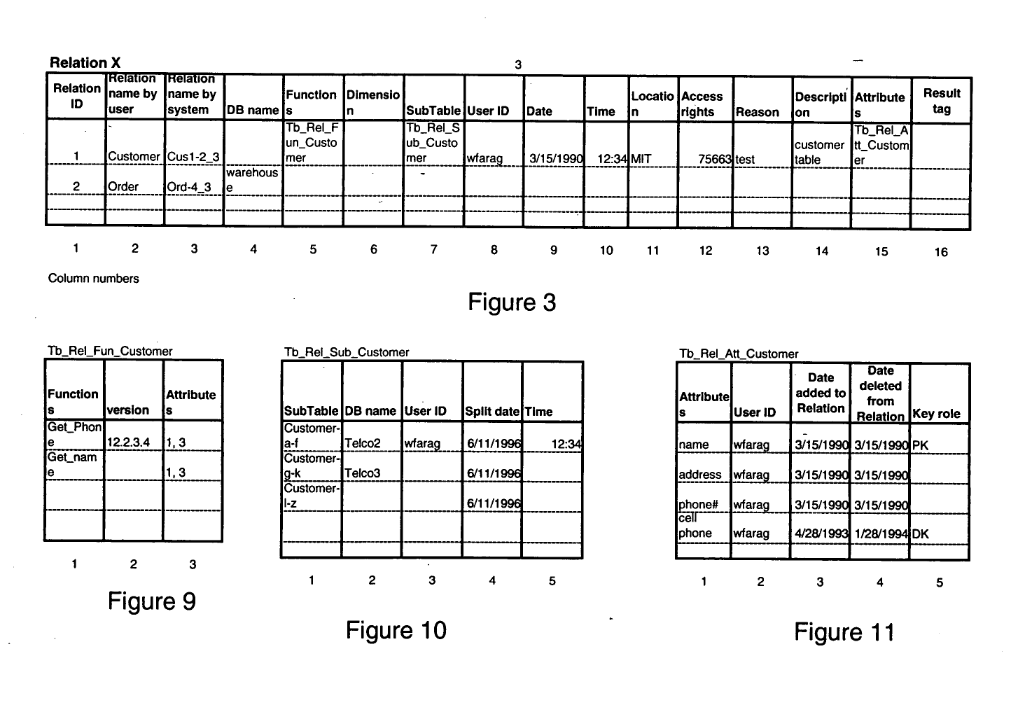

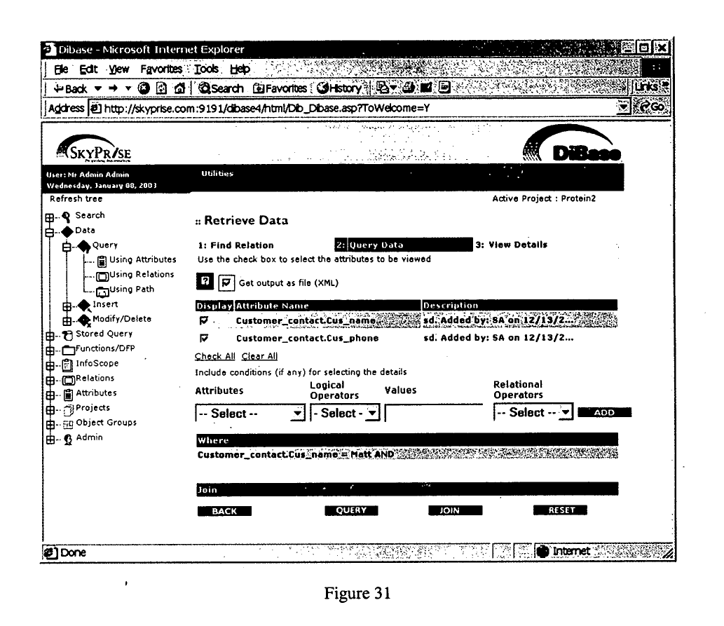

The best way to realize that is to store meta-data information about data and relations in separate tables, see FIGS. 2 and 3, Schema X and Relation X correspondingly, where “X” is the context or schema. Schema X and Relation X replace the data dictionary in the relational model. A number of ways to interact with the system can be by using SQL query like statements, simplifying the transition for programmers, though the concepts are not limited to the SQL query language limitations or its functional incompleteness. Or through a graphical interface addressing end-user needs, see FIG. 31. After describing the two meta-data tables, Schema and Relation, will elaborate a number of user scenario interactions and how data flows through the model.

Schema X

In FIG. 2, best describes an implementation of attributes and their roles in a contextual model. A good approach used in implementing the system, called DiBase (Data-Information-Base), in general, is when a cell within a row has a one-to-many relation to the primary key of that row. The cell value becomes a pointer to a table, Tb_<Table-name_Attribute-name_row-primary-key-value>, where row in the sub table is one of the many values that relate to the one primary key of the parent table row. This allows ease of scalability, though other approaches work better in other cases, see column 15 under Relation X in FIG. 3. DiBase, name of implemented system, has the modules corresponding to each information category: Data=Sebase, Functions and stored queries=FunBase, results=Infoscope, see FIG. 37. This facilitates referencing to the different information categories.

Column 1, Schema ID, is a unique id to reference the attribute name for storage considerations.

Column 2, Attribute name, has an entry for every single attribute in a schema. The attribute name needs to be unique supporting attribute integrity checks for unique attribute naming within a context.

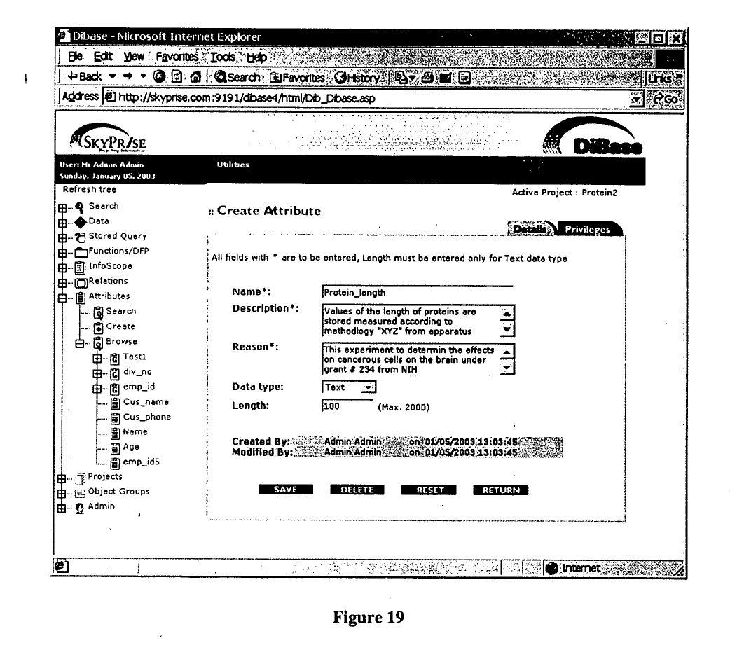

Column 3, Type, captures the data type of the attribute used for table creation, see FIG. 19.

Column 4, User ID, captures the user id that created that attribute. Used for access rights and propagation authority. For example a user could create an attribute and makes it completely hidden from all other database users pending enforced system policies, see FIG. 32.

Column 5 and 6, Date and Time, the temporal data for attribute creation (i.e. contextual meta-data), see FIG. 19.

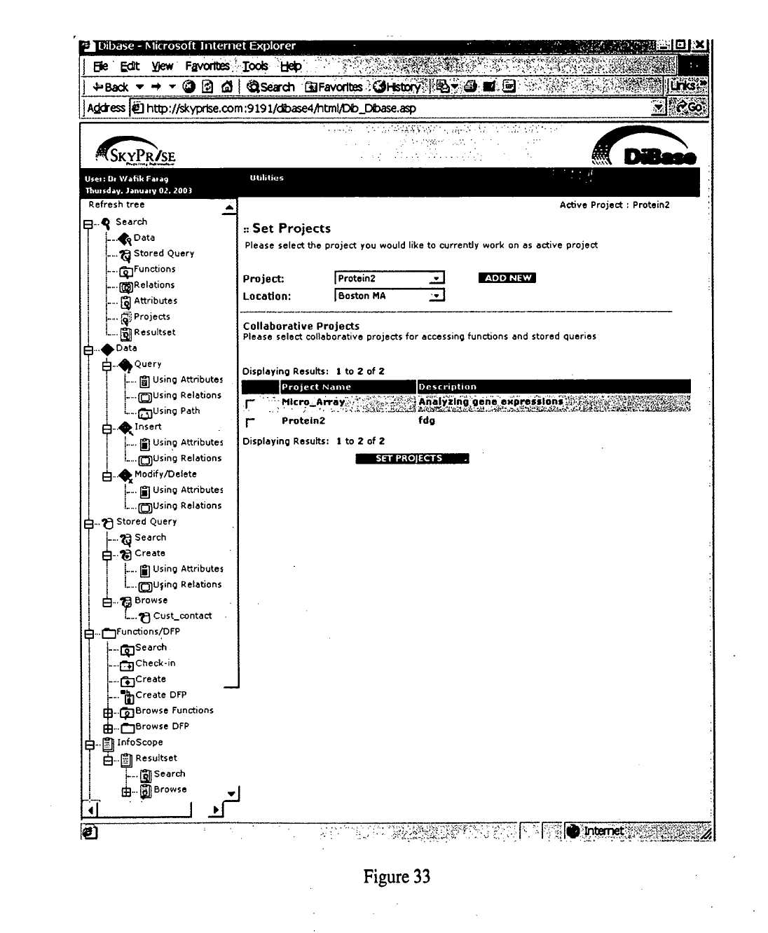

Column 7, Location, captures the location of the attribute when entered. For example, in a biotech experiment, the lab location could have an effect on the experiment, this is an example of contextual information that is captured by the system and is optional. Other contextual attributes could also be added or deleted from the Schema X table. See FIG. 33 at logon screen. Column 8, Assess rights, this attribute plays a role of governing the creation accessibility and integrity of the system. For example, a user would want to store the output of a lab experiment into SeBase to run some data mining functionality leveraging the work of other colleagues like searching for similarities. However, the attributes and the data entered into the databases might not be correct or “cleaned” yet for use by other users on the system. Once a researcher deems the integrity of the experiment data and is approved by a lab supervisor, or according to an approval process, the accessibility could be escalated to the group level, lab level, enterprise level, or world. This allows users to interact with SeBase instead of other storage mediums like flat files of excel spreadsheets which are external and not integrated with the rest of the information platform. This eliminates long design and revalidation periods while allowing immediate access to other researchers once made accessible.

Similarly, a researcher could allow access to certain individuals in other labs for collaboration purposes without affecting the integrity of the over all system. Another way is to store those result in a new context, as a new schemaⁿ, all together ensuring the new context is separate from the first context.

Column 9, Reason, another contextual meta-data to capture the mental model or the user who created that attribute to be available to other users. All attribute meta-data is available to users of the system by pressing on the meta-data button after selecting any data category in the system. This allows new users to the system to navigate and understand the context of the data without the need for a database administrator or a programmer for them to access data within the data model, see FIG. 19.

Column 10, Description, is another contextual meta-data to capture the definition of the attribute by the creator. For example, attribute “name” identifies names of customers in a telecommunication system. This is a searchable field aiding users to find what they want, see FIG. 19.

Columns 11, 12, and 13, Data Source URL, data source name, and data source function, are used to map an attribute from an external source, like another external database in a legacy system or a web site, to an attribute in SeBase. Mapping the attribute could be used as a pointer to the external source's attribute or it could be used to download the data values from that remote attribute. This allows SeBase to sit on top of other external databases regardless of their data model, platform, operating system, etc. and capture new relations between attributes, a mix of external and internal could co-exist. For example, a customer's credit report retrieved from an external credit report database is used to evaluate customers' profile for buying new products. A new relation, customer_profile, which has customer's name, credit report rating, and customer's buying pattern gives insight of which customers with good credit rating buy products. Capturing such a relation by adding customer_profile as an attribute to premier_customers. SeBase allows to capture new relationships quickly and easily without the need to alter models of external data sources. SeBase acts as a relation holder for external sources acting as an integration platform. That is, Sebase could sit on top of existing static relational databases and capture new relationships, as a dynamic database layer, for a static databases or external data sources. The data values of the attributes within those relations will exist in SeBase while all other data values of the underlying legacy database remain as is. This could be used as migration methodology of an archaic schema to a new schema without down time, or as a temporary holder of new relations between schema re-designs of the legacy system.

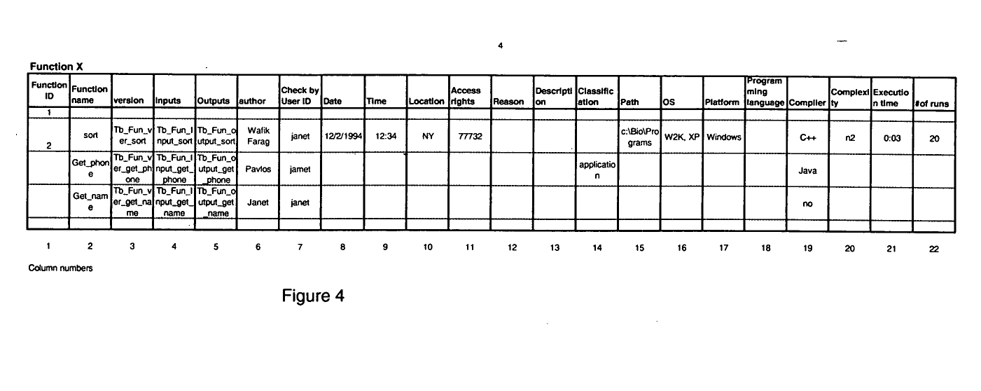

Another use for column 11, is to map external names to an internal naming convention. For example, an attribute is called item_weight and in an external database in France it is referenced as item_poids. The user can enforce that item_weight and item_poids to appear as the same attribute. Column 10 has the URL or path to the external database, column 11 has the name of the attribute as referenced in the foreign database, and column 13 contains the function used to extract the values and integrate them into SeBase. The functions' names stored in column 13, are a pointer to an entry in table Function X, see FIG. 4.

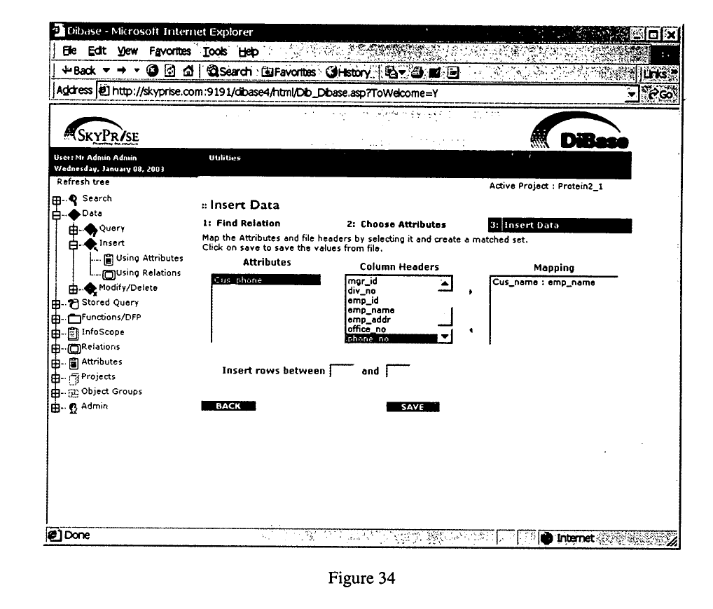

Another useful use for columns 11, 12, and 13 is for batch uploading from an external source. For example and output of an experiment is directed into an excel spreadsheet, that flat excel spreadsheet could be used to as an external source input to quickly upload the experiment results into the corresponding database attributes, even if the nomenclature is different, see FIG. 34.

Column 14, Relations, plays a key role in linking what relations does an attribute exist in and in what role, that is as a primary key, a principle attribute, or a descriptive attribute. Values in column 14 are pointers to tables. The attribute name is the primary key for Schema X. For example for attribute “name” in Schema X, see FIG. 2, has table Tb_Sch_Rel_name as the table name for all the relations that attribute “name” participates in, “Customer” and “Order”, see FIG. 6.

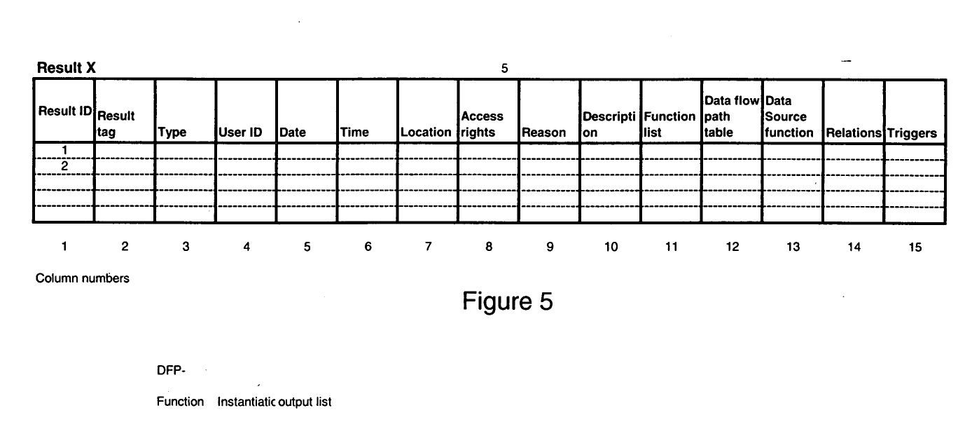

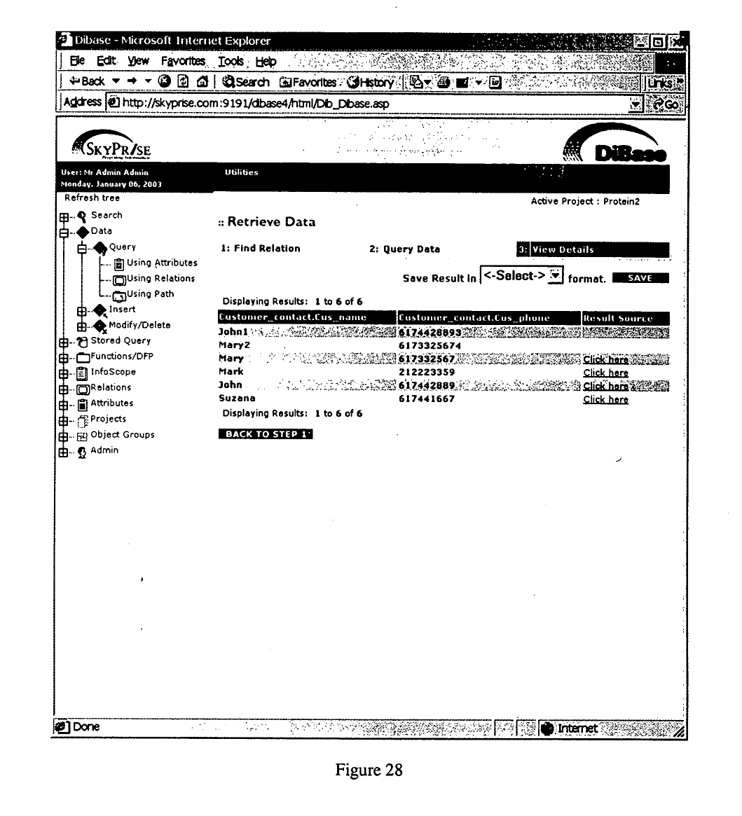

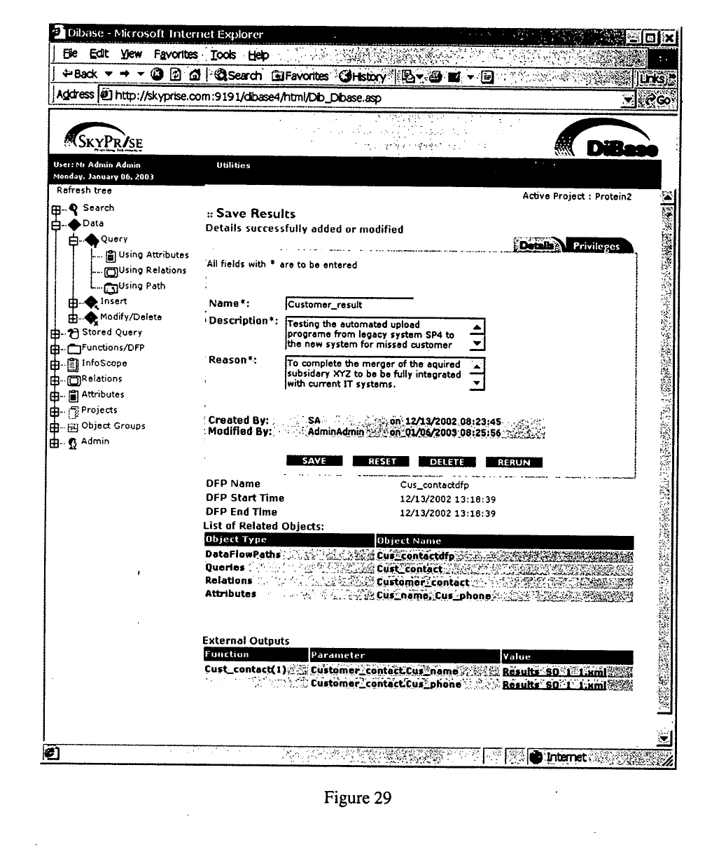

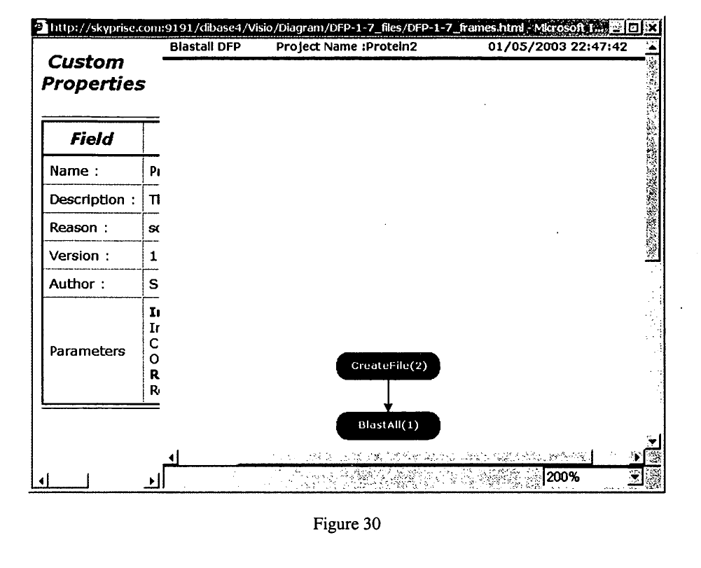

Column 15, Result Tag, links attributes to the result layer, see FIG. 28 and FIG. 29. The values in the Result tag point to the result tag attribute in table Result X, see FIG. 5. This identifies the attributes that participate in a result's “data-flow-path”, that is, if a data attribute is part of the data set used a one or more functions or queries to obtain a result that is stored in the result layer. Once a user decides to store a result all data attributes participating are tagged in this column. Of course, if an attribute is used in more than one result, the values of the cell in column 15 for that attribute's row will be a pointer to a table, i.e. the one-to-many case as discussed earlier. This is used to capture the relation between a result and the data set used. For example, if a user wants to delete an attribute, DiBase will alert the user that a list of result could become non-reproducable.

Column 16, Triggers, is used to enforce dependencies. For example, adding a new entry in attribute price (see row 5 in FIG. 2) triggers an update in a user profile relation as what price ranges a user needs to be alerted when in effect.

Next the relations' table is discussed followed by scenarios for data and function interaction.

Relation X

In FIG. 3, best describes every attribute and its role as a good implementation for the contextual model.

Column 1, Relation ID, is a unique id to reference the relation name for storage considerations. Column 2, Relation name by user, is the name of the relation as given by the user. This allows SeBase to capture a concept in user worldview. For example, in relation customer, attributes: name, address, and phone # are needed to identify a customer and not an employee. Naming the relation is placing a contextual cover for the underlying group of attributes in the relation. Column 3, Relation name automatically generated by system. Some data models restrict relation name to a certain length or format restrictions. In SeBase a user is freed from such restrictions by mapping an internal name of the actual table that will be holding the attribute values. That is, a value in a cell in column 3, is a pointer to the actual table that holds the attributes and data values. The relation naming is best represented as an aggregate key. For example, for table “customer”, assume that the functional dependencies in that table is “name -> phone #”, that is, phone # depends on name and name is the primary key. Since 5^{th} normal form (highest degree of normalization in relational databases) targets binary relationships, Sebase chooses best representation to be in binary form as well. A binary relationship doesn't translate into a relationship between two attributes, but it is a relationship between two group of attributes. For example, the relationship between “name” and “address” could be: “name -> street #, street name, city, state, zip code”. Here, the binary relation is between two sets of attributes one of which is composed of four attributes. Other automated relation naming constitutes a numbering system like Relation_{—}1_{—}2_{—}1.

Column 4, DB name, cells in this column contain the actual database name in which the actual tables together with their attributes and data values are stored. This feature allows the ease of moving one or more tables or parts of tables from one database to another by copying the table into a new database and changing the value of the cell under column 4 that corresponds to the relation/table moved. This also allows different tables to co-exist in different database models, or systems, or platforms. For performance enhancement, a heavily used database table could be moved to another database freeing up the throughput and database engine cycles to other tables. This is particularly important for scalability of the contextual database model. Since the model is not restricted by a single schema, a schema can span over several hardware boxes.

Column 5, Functions, the cells contain a pointer to a table listing all functions that access data from the database utilizing the corresponding function. In our “customer” example, two functions could be written: “Get_Phone” which retrieves the phone number for a given name, and “Get_Name” which retrieves a customer name given a phone number. Those two functions depend on the “customer” relationship. Thus in the table “Tb_Rel_Fun_Customer” will have two rows one corresponding to each function. Also, the versions of the function which use such relationship, it might be all the version, but not always. The third column in the sub table “Th_Rel_Fun_Customer” is a list of the attributes used from the corresponding relation. Let's assume the “customer” relation has three attributes, “name”, “address”, and “phone #”, while the function Get_phone uses attributes “name” and “phone #” only. Then only those attribute id's, in our example 1,3 will be entered. Another implementation encourages function programming to expose the needed data variables as inputs to the function. Stored queries can than be used to link the data source to the function. This alternate method moves the relation between data and functions to the function layer captured by the DFP which allows collaborative users to benefit more from existing functionality and can change the stored query to point to a data source of their choice.

Using the first method, this column is pivotal in supporting the alert features integrity constraints for changes. If a user tries to delete an attribute, which is part of a relation on which a function depends, SeBase will alert the user of a system integrity constraint. Similarly, if a user attempts to break-up a relation or drops an attribute from a relation, system integrity constraints will alert the user. If the user chooses to delete or alter a relation despite the warning, depending on the policy rules, the system can execute the command and the depending functions as well as any related results stored in the result layer will be deleted as well.

Column 6, Dimension, the cells contain a pointer to a sub table which contains the different related relations. The concept of dimension is to capture complex or multidimensional relationships. Any attribute that has a continuous dimension could end up holding complex relationships. For example, a street holds the continuous dimension of a space trajectory. A Street could run through multiple cities. How to represent such a street via a binary relationship is difficult. For example, Mass Ave is a street that runs through number of cities in the metropolitan city of greater Boston like Cambridge, Arlington, Lexington, etc. One could start representing a street by street address numbers. However, if we want to know all the bakeries on Mass Ave., a new relation will be needed. It becomes important to manage the different representations and relationships that an object of continuous dimension might give birth to. Other examples of dimensions are time. For example, to capture the evolution of the silkworm to a butter fly having the same DNA. New relations are discovered revolving around a dimension and this column captures all relations that are related to a single dimension allowing to re-create a world view in the context as needed. The sub tables will have attributes that vary from one dimension to another with basic notions like dependencies, sequences, etc.

Column 7, SubTable, the cells in this column will contain a value when a relation is segmented horizontally for performance, storage space, or other reason. For example, in relation “Customer” if the numbers of customers grow from 2 million to 300 million, one might segment the Customer table into several sub tables for performance reason. Customers with last name starting with “A” to “F” will be in one sub table called “Customer-a-f”, and so on, see FIG. 10.

Of course, each table could reside in a different hardware machine database. See FIG. 10, sub table “Customer-a-f” is stored in a database called “telco2” and sub table “Customer-g-k” is stored in database “telco3”, etc. This feature allows a database to scale in size quickly and easily in a step-wise fashion utilizing smaller and cheaper hardware when needed reflecting a “pay as you grow” approach. See FIG. 23, user can select the database to store in a newly created relation from a drop down menu of available databases. Adminstrator with a dashboard like tool, a tool that keeps statistics about space usage and performance measures for the hardware boxes holding databases for a certain context, can monitor and better load balance or add new databases as needed.

Column 8, 9, 10, and 11, all these columns capture the user who created a relation together with the time stamping of date and time as well as location stamping in column 11, see FIG. 23 as well for implementation display.

Column 12, Access rights, contain values that govern how multiple users can interact with the system while preserving the individual freedom, see FIG. 21. It is similar to column 8 in the Schema X table. This ensures a mechanism of experimenting and applying change without impacting software system that require high standards of stability and integrity like ISO-9002. Accounts could be created for testing and once production level performance is achieved changes are propagated to a targeted group.

Column 13, and 14, both of these columns are similar to columns 9 and 10 in Schema X, red capital A in FIG. 23 will display attribute met-data. The meta-data in the user interface brings such information to the user.

Column 15, Attributes, each cell has a pointer to a table with each row in that table is one of the attributes in the corresponding relation of the same row in Relation X. For example, for row with “Relation ID”=1 in table Relation X, see FIG. 3, the “relation name by user”=Customer. For the relation Customer a new table “Th_Rel_Att_Customer” is created as shown in FIG. 11. The newly created table name “Tb_Rel_Att_Customer” is stored as a pointer in column 15 of row 1 in Relation X. In FIG. 11, all the attributes in relation “Customer”, namely: “name, address, phone #, and cell phone are stored with their role as “PK”, that is primary key, or “DK”, descriptive key. Descriptive keys are not critical to the existence of relation Customer. For example, if a user wants to delete the cell phone attribute from relation customer and create a new relation between “name” and “cell phone”, the system will not alert the user that an integrity of a relation is violated. Descriptor attributes are used to describe one or more attributes in a relation. However, the system will notify the user if functions or results in FIGS. 4 and 5 correspondingly, depend on the attribute “cell phone” being in relation “customer”. Thus, the attribute “key role” in the sub tables of column 15 is a good method to maintain for the integrity constraints of the system. Implementation wise, a number of variations are possible to optimize these data structure representations as long as they maintain the same data-relation separation, only one implementation is discussed here.

Column 16, result tag, has a similar role as the result tag attribute in Schema X in FIG. 2. However, result tag in column 16 in FIG. 3 defines the relations that participate in a result.

SeBase in Action

A number of User scenarios interacting with SeBase are presented. First scenario is creation of attributes and relations. Second, scenarios presents query and insert of data values. For relations, a user wants to find if a relation exists or to create a new relation. Querying about relations allows users to find the latest state of the database without needing to know the design of a particular schema. In FIG. 22, the user can search for relations using known attributes. In FIG. 21, one can examine from the tree on the left handside frame by selecting the browse functionality, existing relations or groups of relations in the system are displayed. Selecting anyone will bring FIG. 23, details about the selected relation.

Similarly, attribute creation and search is available in FIG. 32 under browse provides list of attributes or attribute groups are displayed under the browse in the left handside frame. Also, FIG. 33, a general search functionality at the top of the tree allows to search for any item in any information category.

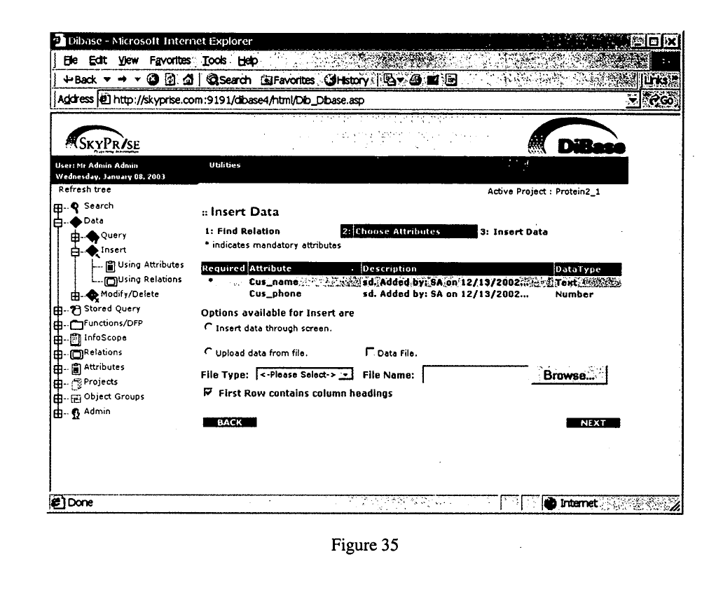

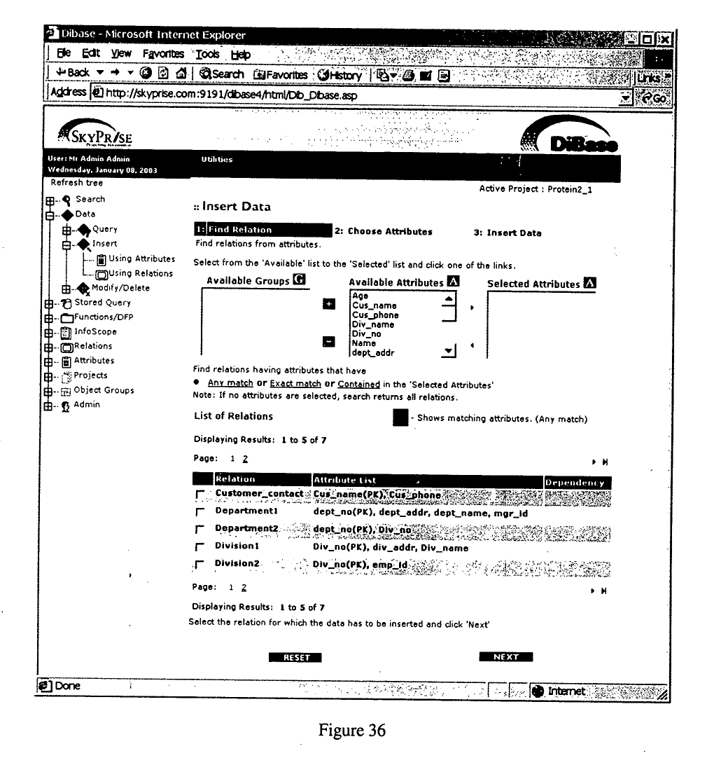

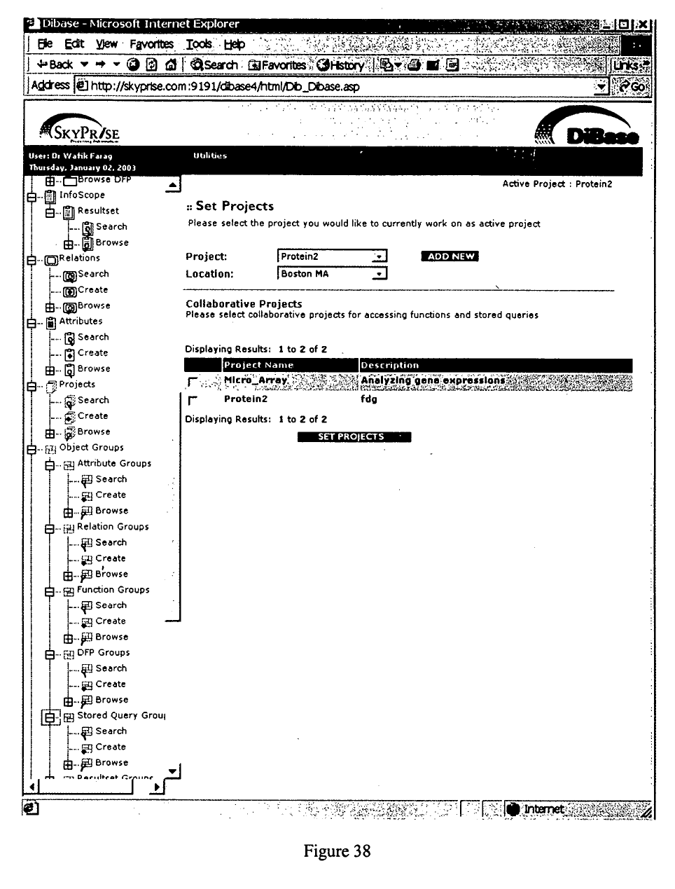

Second scenario, data insert and query, FIGS. 22 and 31 represents web-based query interface. In FIGS. 34, 35, and 36 present steps for the web-based interface for data insert.

SeBase uses table “DiBase Master” table, see FIG. 1, for selecting a user's context. In FIG. 33, in the web-based interface, user at logon selects the context by selecting a project. Projects are the implementation for a schemaⁿ that allows a user to select a context. Once a project is select as the working project, this project will be used for dynamically adding new relations, results, functions, or stored queries. User can select other projects as collaborative projects, see FIG. 33. Once collaborative projects are selected a user can retrieve and only input data values in pre-defined slots into these projects, this is an implementation choice and not a limitation on the system. This maintains the theory that a user can only be in one context at any point in time and that all integrity constraints are based within the context of the working project. This allows users to collaborate without infringing on others. Users can access say a function from another context to add to a DFP or build a stored query to access data from a collaborative project.

Data—Query: Let's Run Through an Example.

Select name from project Protein2 where phone #=555-1234

Step 1:

The above query is instantiated via a user interface, see FIG. 22, which starts by requesting the user to select the attributes they want to find data from. “Name” is selected. The programmer interface uses a quasi SQL syntax like: Select name where phone #=555-1234. It is that simple and does not require table name a key factor.

Step 2:

A list of relations in which the requested attribute “Name” is a member of is displayed. User selects the relation of interest; this is like learning by discovery here about the state of the system at that point in time. This is an optional step, a user could go directly to step 3 if they know the relation they want.

Step 3:

In FIG. 22, a list or relations that contain selected attributes are displayed for user selection. A user selects a relation in which other attribute values are known to the user.

Step 4:

In FIG. 31, the system returns the selected relation(s) with the attributes to complete the query.

Internal System Actions:

In step 1, SeBase lists the set of attributes from Schema X table of FIG. 2. Once the user selects an attribute SeBase goes to column 14, retrieves the table name and displays all relation names in that table, which are all the relations that this attribute exists in. In case of multiple attributes, the returned sets of relation names from the sub tables are intersected. The relation names that appear in the intersected set will be displayed back to the user.

In Step 2, once the user selects a relation, SeBase selects the identified relation from Relation X, see FIG. 3, and retrieves the pointer to the attributes sub table from column 15 in Relation X. All the rows in the sub table are displayed for selection in step 3. In case the user skips step 2, Sebase will populate the set of relations for all the possible attributes that intersect from step 1. In Step 3, once user formulates the query, attributes are instantiated, SeBase re-creates a query with the internal table representations as found in column 3 in Relation X (FIG. 3) and to the hardware box hosting a database as identified in column 4, if available—if blank, the default main databse is selected. Sebase has complete knowledge of the exact table names and attributes. From this scenario, the reader finds that the table name is not needed to retrieve information form DiBase. The user needs to select attributes they are seeking to get values for using what attributes they know. In our example, the user knows the “phone #” value and needs the “name” value and doesn't know if the person in request is a customer or an employee, which is weather they are in the customer relation or the employee relation. In FIG. 31, the relational operators box, fourth box in the query building interface, allows the user to select from two tables by choosing the “or” operator. In our example, the query becomes a compound query selecting from two relations.

Data—Insert

Data insert is very similar to the retrieval process and will be skipped to avoid repetition. See FIGS. 34, 35, and 36. The main different is the user has the option to upload data from external data sources like Excel spreadsheet as in FIG. 34, flat file in certain formats like comma delimited or from other external databases. In the case of the external databases the user needs to create a DFP, select the collaborative project that has access to the external database, formulate a stored query and insert it in the DFP, select the uploadSeBase function to upload data values into the relation of interest. This allows the user to have data from more than one external source or database into the same relation by having more collaborative projects active at the same time and formulate the corresponding stored queries for each data source.

Relation—Create

User creates a new relation between two sets of attributes. Attributes could be new or already existing in the system.

Step 1.

a) The user either selects an existing attribute from the available attributes box, see FIG. 23.

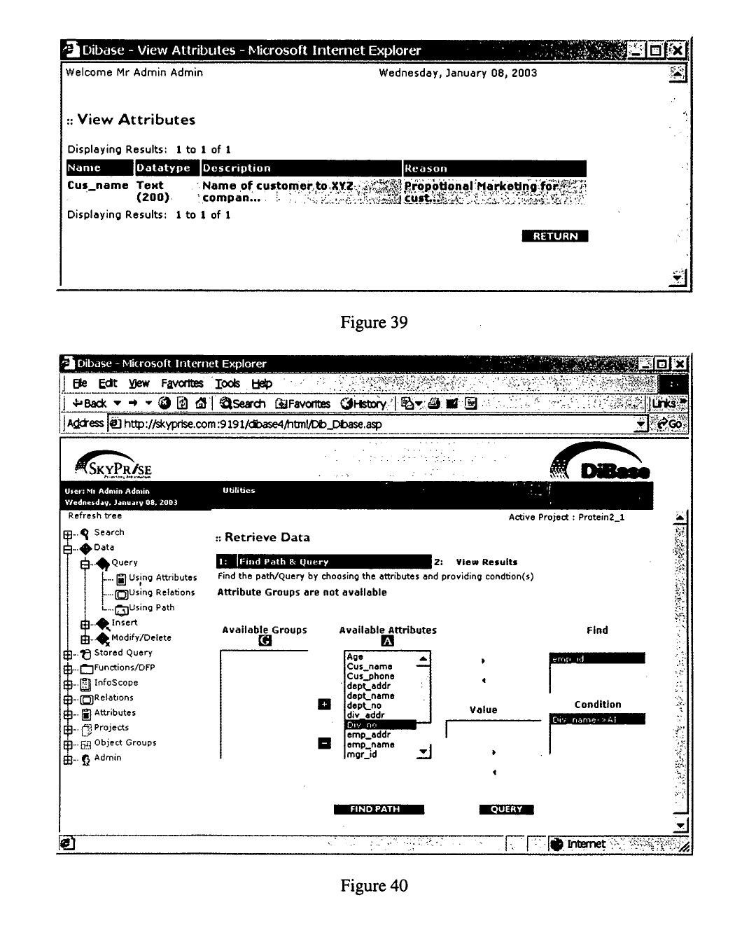

For more information about available attributes, user selects the red box with “A” which returns a pop-up window with detail of the attribute, see FIG. 39. or
b) User creates a new attribute, see FIG. 19. Once the attribute is in the system, user can go to the create relation area.
   Step 2.
   a) Selecting an existing attribute from the available box a user can move the attribute to the corresponding box depending on the role of the attribute, primary, secondary, or descriptive. The selected attributed is deleted from the available box. This step is repeated until the user selects all attributes that need to be in the desired relation.
      Step 3.
   a) User fills in new relation name and meta-data.
   b) User can select a database for storage if available.
   c) User can link the new relation to another relation through insert dependency link to relate relations of different attribute naming. Say a relation has attributes protein_length as one attribute. Another relation has attribute protein_leng. The symentic meaning might be the same and only users can test worldview and representation issues. A user from the description of the other attribute might want to leverage the other relation information by linking both relations.
   d) Finally, user can either save the relation or test for integrity check by selecting the “test” button at the bottom, see FIG. 23. The test allows the user to change or delete if the relation already exist in the system. System displays offending relations for user inspection. See details in the relation integrity engine section below.
      Internal System Actions:
      Step 1.
a) SeBase list the set of attributes from Schema X table of FIG. 2. Once the user selects an attribute. SeBase selects values of column 14 corresponding to the selected attributes, retrieves the table name and displays all relation names in that table, which are all the relations that this attribute exists in. In case of multiple attributes, the returned sets of relation names from the sub tables are intersected. The relation names that appear in the intersected set is passed to the integrity check engine with all the attributes available in the set.
b) In case of a new attribute, Sebase inserts a new row entry in Schema X, where X is the corresponding users context, project in our implementation. User fills in new attribute name and meta-date, see FIG. 19. Some of an attributes values like location, user ID, data, and time are automatically filled using the contextual information about the user.
   In Step 2,
   a) Once the user selects the attributes for the relation to be, SeBase builds a list of all possible relations in which those attributes exit from Relation X, see FIG. 3, and retrieves the pointer to the attributes sub table from column 15 in Relation X. All the rows in the sub table are compiled for the integrity engine. Sebase maintains the attribute grouping on each side of the dependency for the the two sets of attributes. The descriptor attributes are dealt with as a special case as they don't affect the binary relation constraints
      In Step 3.

SeBase inserts a new row in table Relation X with the new relation only after the integrity check for the relation is passed. SeBase populated a new row in every table pointed to by column 14 in table Schema X that correspond to the selected attributes. Sebase also creates a new table with name from column 3 of table Relation X and stores it in database as indicated in column 4. A user could select a database destination if available. This new table will have the set of selected attributes. In case of insert dependency, columns 11, 12, and 13 are filled correspondingly.

Find Path

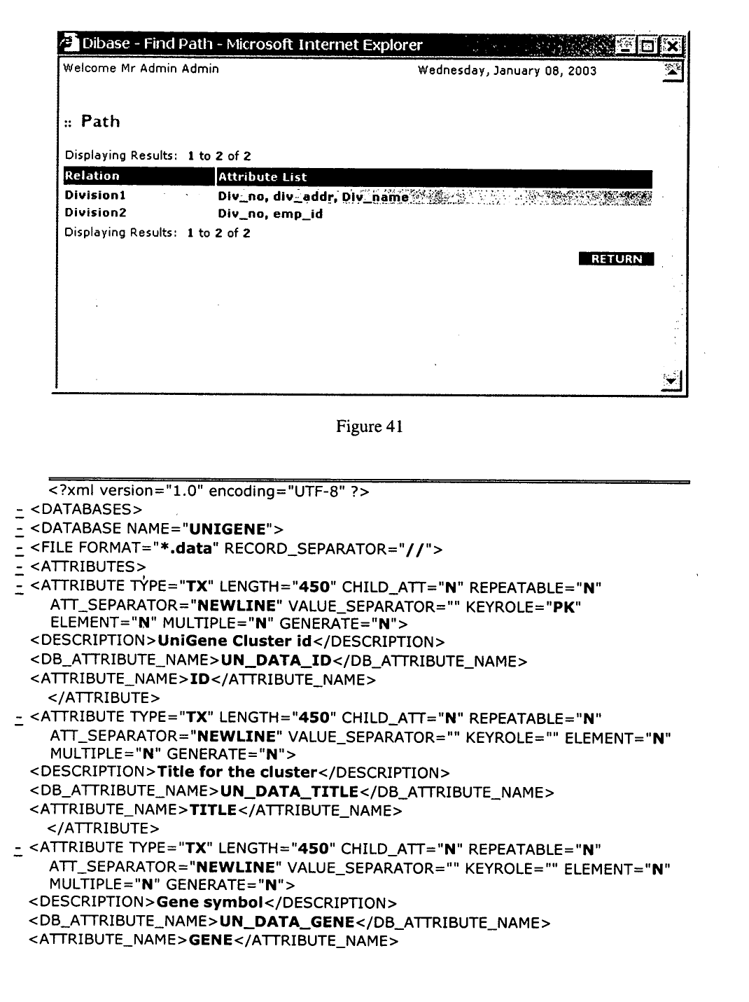

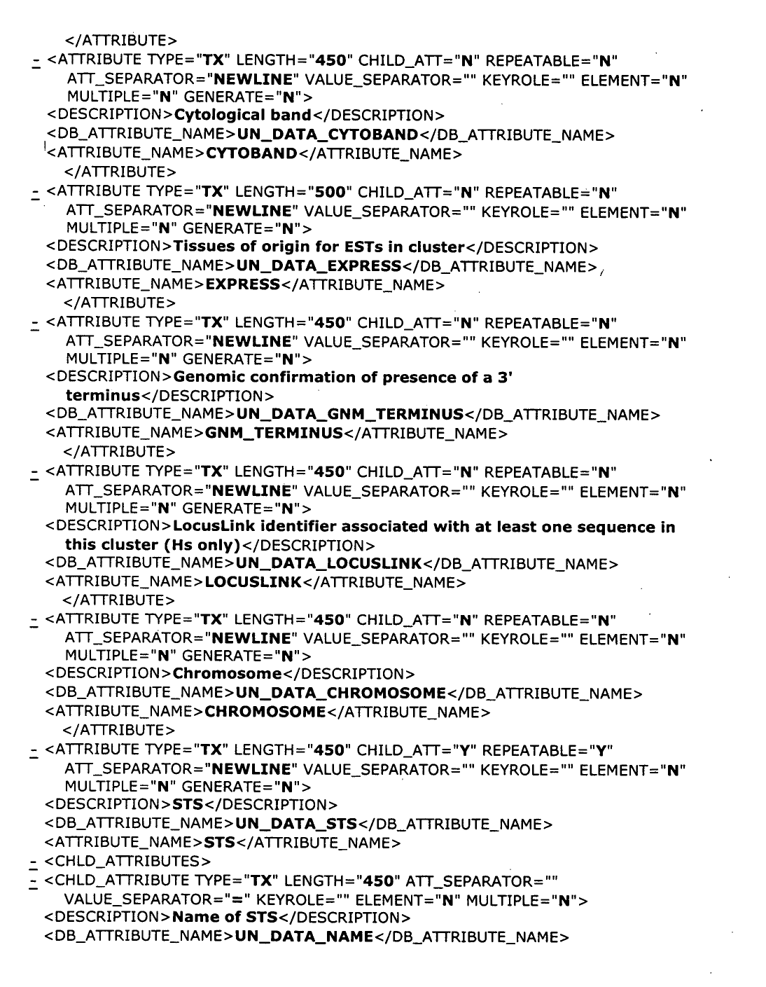

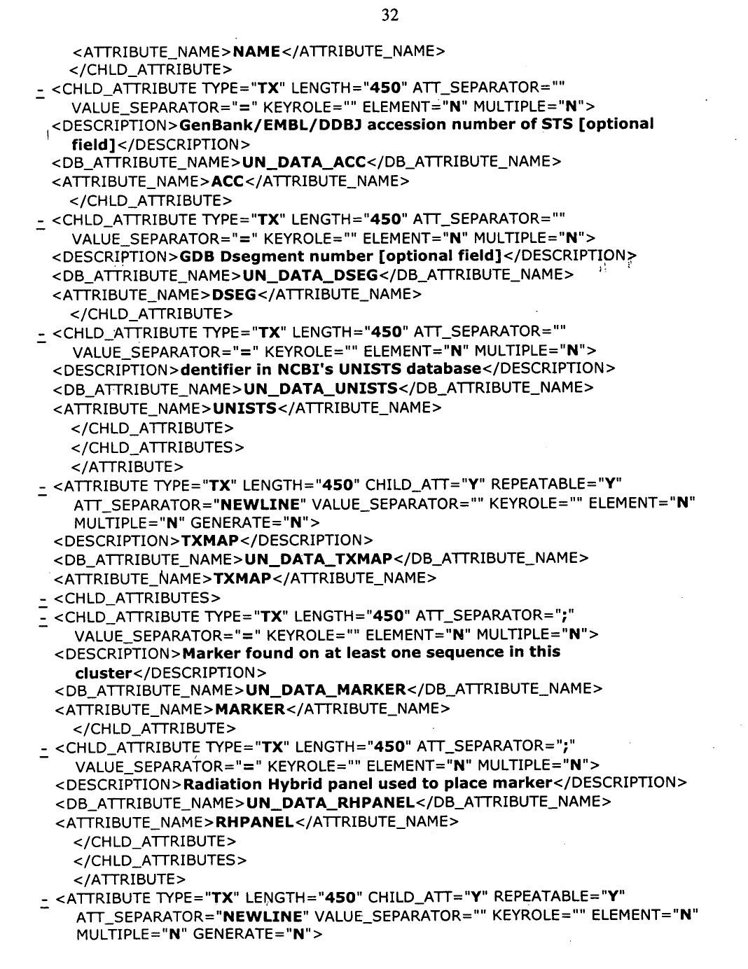

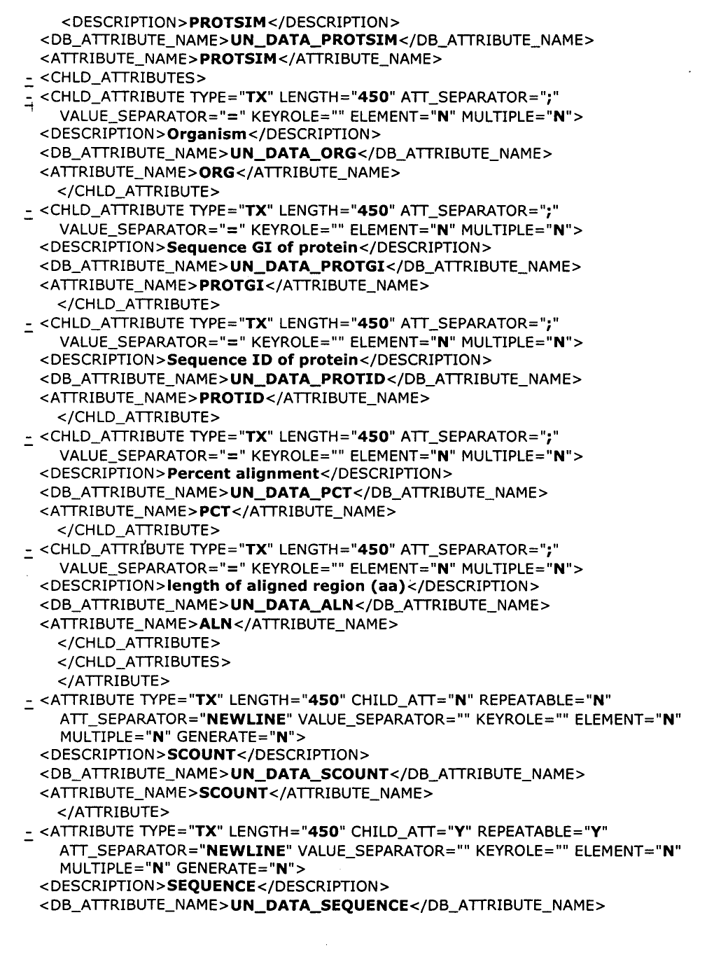

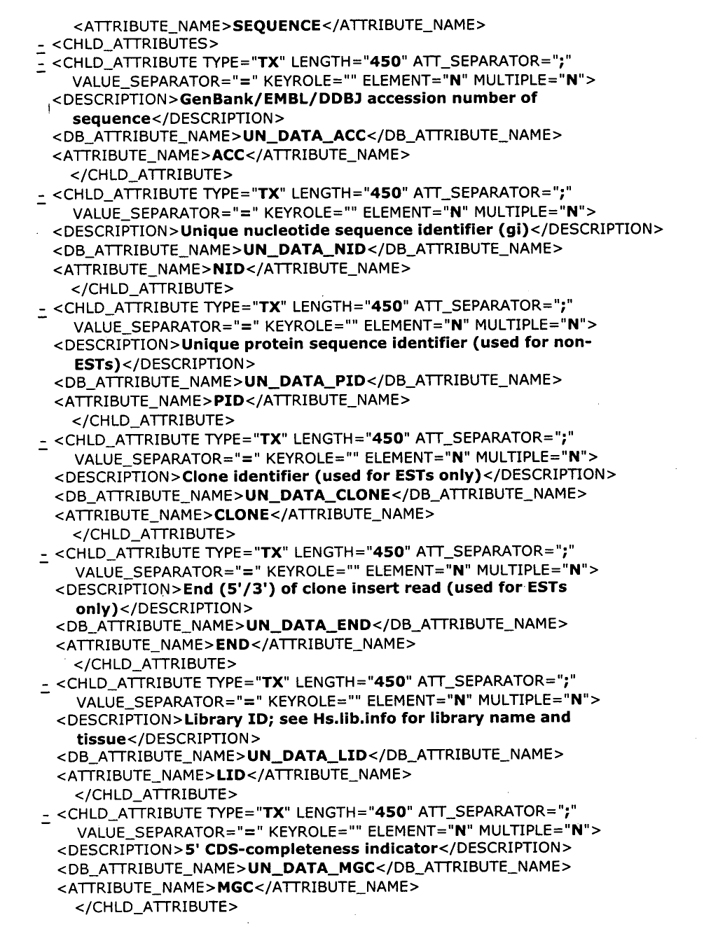

Sebase can simplify the search for the user by requesting from the user to enter two attributes and find if a path exists between them, see FIG. 40. For example, let's say a user has a phone # and is not sure if the persons name will be retrievable given a phone #. If the two attributes are not in the same relation but exist in relation that have common joining attributes, than the query can be fulfilled. FIG. 41 displays list of relations that contain the two attributes as entered by the user in FIG. 40, emp_id and Div_name, which can find the solution requested. The user displays the pop window of FIG. 41 by selecting find path. Otherwise, to get the answer, the user will select query.

Find path is another implementation displaying the user freedom from needing to know the underlying database model. In case of DiBase, the data model changes all the time, hence the user needs such tools.

Below is an algorithm for finding a path between two attributes:

Given two set of attributes (X, Y) we should be able to get the unique path between them
1. The Path between X and Y exists if Y is in the Closure of X
   a. Find The Closure of X over the existing FD's in FDTable
   b. If Y exists in Closure of X than there is a path between X and Y else There is no path between the given attributes.
   c. For every attribute in X find a path to every other attribute in Y.
   for finding the paths:—
      i. create a acyclic graph using the Fds in ClosureFDsList, while creating the adjacency matrix for the graph for every edge also maintain the relation and FD causing that edge.
      ii. use the FindPath algorithm to find the path, if for two consecutive edges and BC the relation differs (say R1 is for edge AB, R2 is for edge BC) than add condition R1.B=R2.Bto outputPath
   d. The Union of all the output Paths form the Path between two sets of attributes

Algorithm FindPath

```
FindPath between attribute s and attribute d:-
{
Int n = no of attributes
Path( ) array of n elements
Path (0) = S
Length = 0 // current path length
Destination = d
//mark of the attributes as not reacached
for I = 1 to n reach(i) = 0;
//search the path
if (s==d or rfindPath(s))
{
  NewPath an array of length + 1 attributes
  copy length +1 elemets from Patah to new path
  return newpath;
}
else
  return null;
}
recursive function:
rFindPath(s)
}
reach[s] = 1;
for all vertex u adjacent to s
{
if reach(u) == 0 //u is not reached
{
```

length ++

path[length] = u,
if (u == destination ) return true
if (rfinfPath(u)) return true
//no path from u to destination
length −−

}

}
return false
}

For the closure functionality mentioned in the find path algorithm, below is the algorithm from prior art¹
¹

Algorithm CLOSURE

Input : -A set of attributes X and a set of FDs F
Output :- the closure of X under F (list of all the attributes which
can be reached from X)
ClosureFDsList:- List of FD's which were used from the closure
CLOSURE(X,F)
Begin
ClosureFDsList = null
OLDDEP := Null , NEWDEP :=X
While NEWDEP <> OLDDEP do

Begin

OLDDEP := NEWDEP;
For every FD W→Z in F do

If W is in NEWDEP then

NEWDEP := NEWDEP U Z
ClosureFDsList = ClosureFDsList + W→Z

End if

Next

End

Loop
Return (NEWDEP , ClosureFDsList)
End

This is added here for completeness to clarify meaning of Clousre as used in the path algorithm.

Features of Sebase:

A database model “contextual model” allows changes to relations among data attributes to be captured on the fly. Multiple schemas could co-exist in SeBase.
Can act as a storage layer for new relations for underlying legacy systems or external data sources.
Is agnostic to the underlying data source or storage area. Could vary from a flat file to a relational model, an object oriented model or a mix of all.
A new process for propagating access rights to the attribute level, relation, upto the schemaⁿ level.
A user can establish a new relationship with no design process applied to the whole schema.
System notifies a user if a newly created relation violates an existing relationship. The user has the choice to enforce the new relation thus losing access to the existing relation, this policy is not recommended in practice. An alternative more acceptable solution is once a user finds that the relation to be created is in conflict and still wants the relation, the user can create a new project, i.e. a new context, and store the conflicting relation in the new project. This enables users to maintain different context even if in conflict. Other system users will not be aware of the newly created conflicting relationship until propagated by an administrative authority.
   FunBase: Function-Based Model

Functions in a software system have taken the middle layer of a functionality server. No linkage to the data layer has been made. A number of system like revision control systems or source control systems keep track of functions for the versioning and changes within a single function and not with what the function interacts with. Other systems allow users to build workflows using a set of existing functions. Two things that need attention is the ability for users to check-in functions through a networked application and the on-the-fly storage of the result of a function or sequence of function that contain new attributes or relations.

Funbase is an open platform for checking in functions. To best describe some of the capabilities of functions checked into FunBase, some examples are mentioned together with installation process in the “Application and Function Installation Manual”

Manual is attached as a separate document.

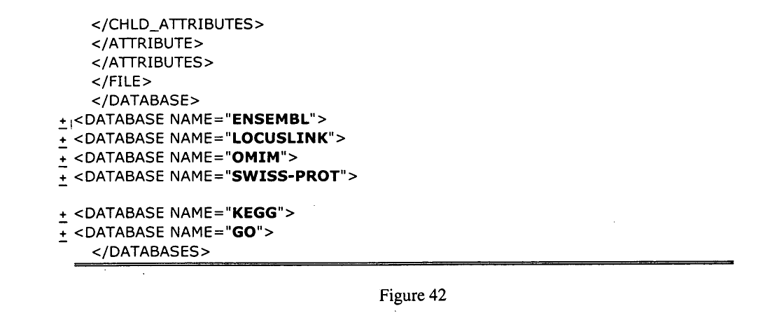

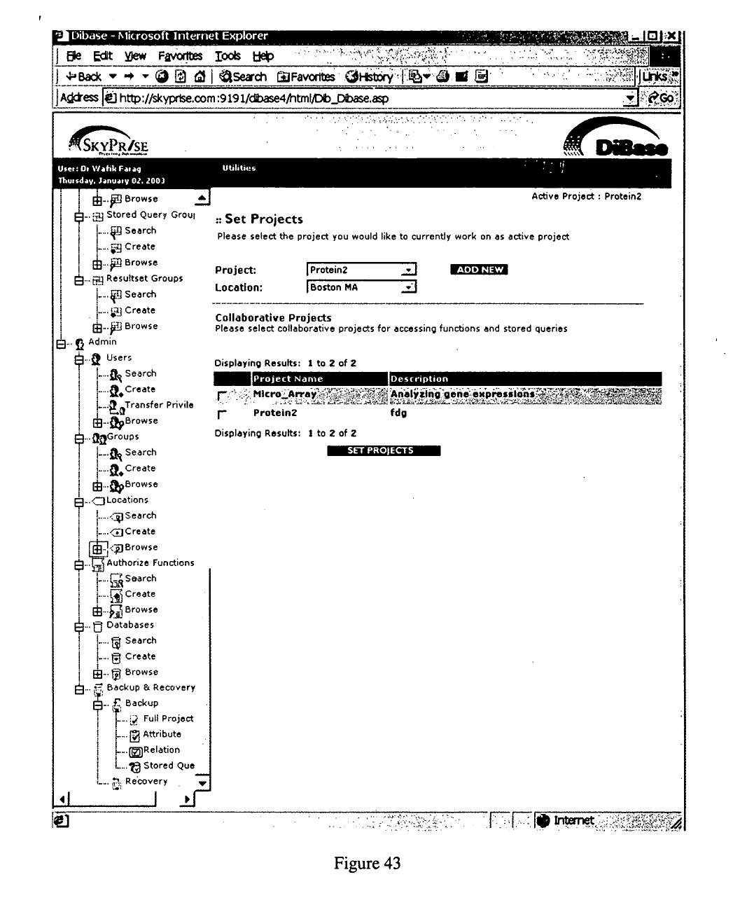

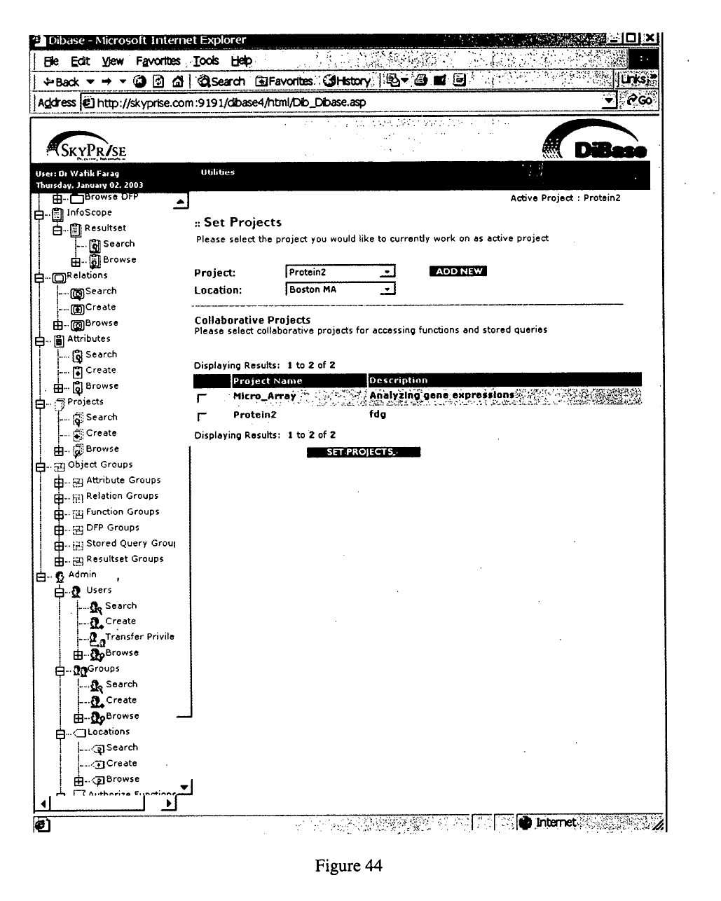

To better understand the power of an open platform, one can see the FTPupload function that uploads databases from external sources and automatically creates corresponding relations into SeBase. FTPupload function is a generic database upload engine that takes an input file, see FIG. 42 for a sample file of one of the NCBI databases, in an XML format for identifying the underling schema of the external database uses that to create relations in Sebase and than uploads the corresponding data values.

A model is presented for storing, retrieving functions as well as executing them based on contextual dependencies.

First will explore the table Function X in FIG. 4 in DiBase.

How it Works

Function X

In FIG. 4, 1 will explain the different attributes and their role.

Column 1, Function ID, is a unique id to reference a function for storage

Column 2, Function name, is the name of all functions used by the application.

Column 3, version, uses DiBase sub table scheme for one-to-many cases. This allows users to change functions or modify them while maintaining older versions. This is similar to a source control system

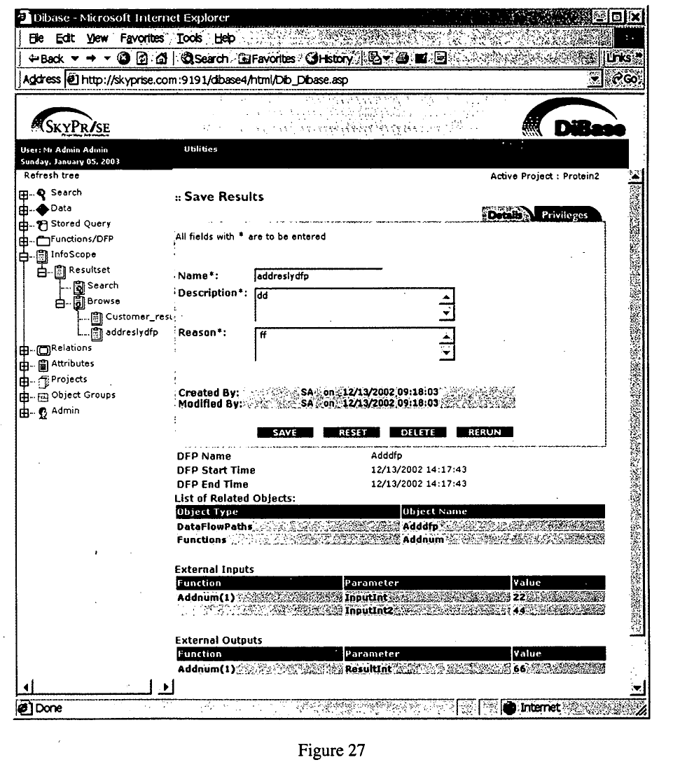

Column 4, Inputs, here a list of input, data or user inputs are identified and used for searching. Users can add new contextual inputs to a function thought no actual input is required. For example, a function “mapquest” returns a set of directions given two inputs: origin and destination. However, it is assumed that it only works in USA. A user could create a new version of function “mapquest” qualifying an input parameter as country, which gets instantiated from a users context information. In this example, if we have another function called “mapeurope”. A user with a cell phone who requests direction will still enter only two enteries: origin and destination, while the context of the country could be retrieved from the cell phone network information. See FIG. 27 for some categorys of contextual data that is used to qualify and select functions.

Column 5, Outputs, are the list of outputs of a function. One-to-many scheme is used in this column as well to store all output types of a function. This allows users to query about a function by its output.

Column 6, author, is the person who wrote the function and has full access rights of change.

Though once a function is checked and made available to all users and used by them, deletion will require an admin approval.

Column 7, 8, 9, 10, 11, Check by user ID, identifies who checked a function together with time stamping and authentications and location etc. This is similar as in Schema or Relation tables in FIGS. 2 and 3 respectively.

Column 12, 13, are user entered meta-data information about a function.

Column 14, classification, is a set of classes that a group in a project or a team agrees upon and facilitates search. Allows users to create context for functions within an application and becomes selectable for new functions. Examples for classifications are: clustering, data mining, conversion, etc. where functions of such a class are stored.

Column 15, Path, is where a function is stored, it could be a URL, or a path on a network, etc.

Column 16, OS, the operating system that a function could run on. This address variation like different flavors of Unix or Linux.

Column 17, Platform, is it windows, Mac, Unix, etc. Gives users idea if they find a good result obtained by a function that runs on Unix and they run on Linux that compatibility issues are not major like running on Mac. Users will be more willing to spend the time to modify the function for the similar platform. A user could also have in their context what platforms or OS do they have access to or are familiar with, thus restricting the search.

Column 18, and 19, both of these columns can be used in a variety of ways. For example, a user wants to find any data mining function that runs on Windows 2k, written in C, and has complexity less than n².

Column 21, and 22 provide usage and statistics about a functions use.

FunBase in Action

A key benefit for users to check in their functions into DiBase is to keep the integrity of the software system. Linking functions with data and results provides a holistic view for users. In addition, because DiBase brings the power of change to the end user, more integrity constraints need to have a place holder to enable their existence.

In addition, the output of a function could be stored back in the database even if it is a new relation or attribute.

Users who check in newly created functions enhance collaboration by making this function searchable to the fellow users. For example, a financial analyst who writes a function to perform a market outlook based on some criteria and result in positive predictions may attract users attention. Users who observe the results can track in DiBase which functions or sequence of functions used to achieve such a result.

Infoscope—Result Layer
Find results obtained via function x, where function x is a particular version of a function.
What data sets are used to obtain this result
What user assumptions were used in instantiating a function used for a particular result.

These are some of the benefits of having a platform that can store results. With the decrease in storage costs and increase in the value of information, storing the results might be more valuable than leaving them on paper. This is one of the aspects I identify as return on information (ROI). For example, in the biotech industry, a drugs life time spans over numbers of years and can exceed a decade. Once a drug is found and submitted to the FDA for approval, recreating those early on results to substantiate one's claim becomes difficult.

Infoscope allows a user to store a result of interest. InfoScope stores the data sets used as inputs, the sequence of functions with the specific variable instantiation, and the result.

Let's examine table Result X in FIG. 5, where X is the context within which results are obtained, see DiBase Master table in FIG. 1 column 6.

Result X

For the sake of brevity, will highlight the significant columns of interest. A lot of similarities exist in the other master meta-tables like Schema and Relation, FIGS. 2 and 3 respectfully.

Column 12 is a pointer one-to-many scheme that captures the whole data-flow-path of data. That is what data sets are used in a result, functions and their particular versions, the user input for function variables etc. Having result X as part of the DiBase platform facilitates the tagging and capturing of such information.

Column 15, identifies dependencies to be executed when a result is re-run.

Results come is different data types, it is also anticipated that functions could be a type of result to be stored. In case of the different data type, SeBase can manage as discussed utilizing its dynamic aspect. If the result is a function or a stored query, Dibase will handle such cases as the check-in procedure is a dynamic open platform for functions as well.

This gives a brief view of the importance of the result layer to fulfill requirement such as 21 CFR Part 11 for drug approval process. It provides a complete electronic signature for the different items in all information categories involved in producing a result. For example, a result that was obtained in year 4 of a drug research, can easily be re-run, see FIG. 29, at year 8 to cover newly added data sets and investigate if the previous claim still hold.

Integrity Engine

An integrity engine utilizes a set of rules to maintain system correctness. This shield users from corrupting the system by mistake, hence enables non-technical users to interact with the system at all information category levels. This in return enables collaboration of end-users to interact and benefit from the system's capability of sharing and tracking items from all information categories.

Integrity rules can change depending on the policies and procedures of the organization. These are rules that an administrator can modify like to the access of users to certain projects as an example.

However other integrity rules is not suggested to be changed and the following is best representation of such rules:
Attributes: There will be two groups of Attributes. Each group can have primary and secondary attributes.
   Primary Combination of attributes is unique
   Secondary Combination of attributes can be repeated.
   An attribute can be descriptor attribute to a single attribute or a group of attributes in case of primary as well as secondary attributes
   An attribute can have one or more descriptor attributes
Relations:
   A Relation cannot be created on a single attribute (HelpNote: If a user wants to create a relation with single attribute, he can create a new ID attribute and then create relation between these two attributes. Eg: To create a relation with attribute name the user can create another IDattribute and then create a relation)
   The path between two Relations must be unique.
   For Eg:
   E.g. consider the following relations
      a. R1:EmpAddress (Name, Address)
      b. R2:EmpPhone (Name, Phone)
      c. R3:PhoneMake (Phone, Make)
   Suppose R1 is related to R3 via R2.
   This means that EmpPhone is required to complete the relation between EmpAddress and PhoneMake. So the path R1-R2-R3 is unique and there cannot be another path between R1 and R3 defined within the system.
   Refer Annexure A,B,C
When modifying/deleting objects, the dependant records in all related tables within the system should be updated accordingly.
   If Attribute is referenced in one or more Relations:
   Deletion Not Allowed
   Modification Allowed for the Following:
Description field of the attribute can be modified. When modifying the description, the old description can/requested to be retained and the new description should be added to the existing description.
Length Field of the attribute can be modified to a higher length only. This is only for Text Datatype. (**Integer Length cannot be modified. The standard range for integer is −32768 to 32767. The
Length of the Integer field will be 6
Data Type field of the attribute can be modified to a Compatible type only.
They are:
Integer to Number
Integer to Text
Number to Text
Date to Text
   If Attribute is not Referenced in any Relation:
Deletion Allowed
Modification Allowed
   If Function is referenced in a DFP within the current project or another project:
Deletion Not Allowed
Modification Not Allowed
   If Function is NOT referenced in a DFP within the current project or another project:
Deletion Allowed
Modification Allowed
   If DFP is referenced (i.e. if Results are saved):
Deletion Not Allowed
Modification Not Allowed
   If DFP is NOT referenced (i.e. the Result is NOT Saved):
Deletion Allowed
Modification Allowed
   If Authorized Function is tied within a Checked-in Function (i.e. a Function uses this Authorized Function):
Deletion Not Allowed
Modification Allowed only of Environment details (i.e. data)
   If Authorized Function is NOT tied in any Checked-in Function (i.e. a Function Does Not use the Authorized Function):
Deletion Allowed of the program type and the Environment details
   Modification Allowed of the program type and the Environment details
   Projects Addition/Modification:
   SA, Site Admin and Project Admin can delete a Project.
   Owner cannot delete projects unless he is a SA, Site Admin or a Project Admin
   If the Project is not referenced in any other project within the system
Deletion Allowed.
   The corresponding record in the Projects table should be deleted
   All the related objects should be deleted
   All the related tables including the counter tables should be dropped
   The user privileges and the project privileges should be updated accordingly
Modification Allowed
   If the Project is referenced in any other project within the system
Deletion Allowed.
   Eg: Project P1 has a Function F1.Project P2 has a DFP which constitutes of functions from Project P2 and also Function F1 of Project P1
   When creating the DFP in project P2, record the details of inclusion of the Function P1.F1 within the DFP in the database against project P1
   When Project P1 is to be deleted warn the user that P1.F1 is used in P2.DFP and ask the user if project P2 can be deleted. If allowed then delete the project P1. This will make the DFP in project P2 Invalid.
Modification Allowed
   Only objects of the project which are NOT referenced by any other project within the system can be modified

The above rules list best practices for system integrity. Especialy the inter-category integrity rules between Data, storedQuery, function, and results, what are refered to as inter-category rules.

DiBase uses other rules that are known like Data integrity. Data integrity ensure when an attribute is of data type text to expect text. This is important when storing results into attributes in SeBase.

Attribute integrity is best used to ensure uniqueness of attribute naming.

Relation Integrity

Relation integrity provides best practices of when to accept a relation into the system without violating system correctness. Loosely described, system correctness ensures that a user gets consistent answers to the same query for the same system state. If the state of the system changes and other values or relations are created, than the result can change which does not conflict with the correctness of the system.

Relation addition into SeBase is best described by the following set of rules:
A relation can be added only if:—
1) All the attributes in the new relation do not exists together in any other relation
2) Grouping of attributes: relations are binary defining only one Dependency among attribute groups.
   say attributes A is a subset set of attributes X in new relation (X→Y) and if A exists in any other relation than all attributes in A should be grouped together in the existing relation
   say attributes A is a subset set of attributes Y in new relation (X→Y) and if A exists in any other relation than all attributes in A should be grouped together in the existing relation
   say attributes A is a subset set of attributes in R(X,Y) A(xi,yi) and if A exists in any other relation than all Xi's in A should be grouped together and all Yi's should be grouped together in the existing relation
      3) create a set of attribute using the following steps:—
   a) Build the List containing attributes in X
   b) Add all the attributes in all the relations containing one or more attributes in the list to the list
   c) Repeat step b till the list does not change
If one or more attributes in y are in the list than the relation cannot be added, if List contains no attribute in Y than only the relation can be added.
4) Elements on the RHS (all or subset) should only be with the elements in the LHS of existing FDs or new element they should not exist with any other element in the list built in step 3.

For any FD X->Y we need to keep a list of all attribute groups in X, i.e. the left hand side of a relation (i.e. FD). X or a subset of X in any existing FD can't appear with any other attribute from the list created in step 3 below as an X (i.e. the left hand side of an FD) in a new FD. Eg:—Say we have FDs ABC→DEF and DEF→GHI then if a user comes to define a new FD (AH→K) . . . Rule 1,2, and 3 will Pass but Building the List of LHS containing A we get (ABC) hence A should exists only with B,C or any new element not in the list (ABCDEFGHI), H is in the given list hence FD(AH→K) can not be added to the context.

Let's Examine Some Examples Using the Above Rules on a Set of Relations:

Assume a blank context. User defines relation R1(A, B, C,D,E,F)

FDs:—ABC→DEF—passed

User defines relation Rx(AC→B)—fails by rule 1

User defines relation R2(DE->GH) (rule1 passed, rule 2 passed rule3 passed, rule4 passed)—relation is stored.

Context state=relations in the system R1(ABC→DEF), R2(DE→GH) User defines Rx(AD→H) (rule1 passed, rule2 failed since AD are in different groups in R1 hence addition of this relation is not allowed

User come to define Rx(AG→H) (rule1 passed, rule2 failed since GH are in the same groups in R2—failed.

User defines Rx(AB→GHI) (rule1 passed, rule2 passed, rule3 failed) List(A,B,C,D,E,F,G,H) contains GH hence addition of this relation is not allowed

User defines R3(AB→I) (rule1 passed, rule2 passed, rule3 passed)—passed and stored.

Context state=relations in the system R1(ABC→DEF), R2(DE→GH), R3(AB→I)

User defines Rx(G→A) (rule1 passed, rule2 passed, rule3 failed List(A,B,C,D,E,G,H,I)—failed.

User defines Rx(EF→I) (rule1 passed, rule2 passed, rule3 failed)—failed.

User defines Rx(AI→J) (rule1 passed, rule2 failed since A and I are in different groups in R3 hence addition of this relation will not be allowed

User defines Rx(AH+J) (rule1 passed, rule2 passed, rule3 passed, rule4 fails, A is in ABC in R1 and A can't be with any other attribute from the list of rule2 except BC i.e. A,B,C,D, E, F, I, H, G. Thus AH -> J fails.

Backup and Recovery

The following objects will get Backup/Restored
Selected Project and its dependencies (includes Attributes, Relations, Relation Data, Stored Queries, Stored Query Results, Functions, Function Implementation Details, Data Flow Paths, Function Parameters, Users, Groups)
Selected Relation and its dependencies (includes Selected Relations, attributes & Relation Data)
Selected Stored Query and its dependencies (includes Selected Stored Queries, Relations, Attributes & Relation Data)
Operational Objects (includes Users, Function Implementation Details, Program Types, list of Databases & Groups)
Infoscope(Includes ResultSet Objects)
Encryption & Compression:
   The backup file will be encrypted and compressed, which will not be understandable by any person.

Admin is backing up a project. After Backup of selected project, Dibase system will give a list of external references, which are referred in the selected project. A function ‘FUN_A’ in Project ‘Proj_A’ is referring a Function ‘FUN_B’ in another project ‘Proj_B’. If we are backing up Project ‘Proj_A’, dibase system should list ‘FUN_B’ along with Project Name ‘Proj_B’. While Restoring a Function which has got some Stored procedure/Dll Reference, the Function Implementation of that particular function will be set as unauthorized. Because we have restored only the meta data(function name, description, parameter details) & implementation details of that function, not the original Stored Procedure/Dll. Admin will set it as Authorized, once he copies the corresponding Stored Procedure/Dll to the new project database. A list of Functions has to be provided to the Admin, these implementation details has to be authorized Admin is Backing up a project, which has external reference in some other projects. Backup captues referenced project details (name, Desc.,), provide user a facility to map the projects while restoring.

Backup & Recovery of Data Spread Across Multiple Databases.

Backup: Backup the relations with the same Database reference.
Recover: While restoring, check whether the database exists or not, if exists then put the data else user is provided an option by which on how to map the databases.

Audit log details like Created Owner, Created Date, Modified user & Modified Date. will also get backed up. Backup the related User as well with the Object (Project/Relation/Stored Query). while restoring check whether the user exists in the dibase system or not. if exists then don't restore and use the login name of user everywhere. if user doesn't exists then create a new user. After restoring all the objects make the new user as inactive. Only admin can change to active. Backed up filename will be combination of Timestamp, Object Type of Backup with the extension .dib.
Prj_MMDDYY_HHMMSS.dib ------ For Project Backup
Rel_MMDDYY_HHMMSS.dib ------ For Selected Stored Queries Backup
Sqry_MMDDYY_HHMMSS.dib ------ For Selected Stored Queries Backup

Backing all information categories into operability brings an open approach to exchange and collaboration. Users do not have to separately backup different categories and reassemble later during restore where inconsistencies pose a problem.

Data Integration

DiBase™ platform is a dynamic collaborative web-based software system that solves a number of key integration challenges. Data integration is an example of a widely discussed problem that DiBase solves without customization or a change in the architecture. This best tests the openness of the platform to different implementations.

DiBase™ tackles the complex issues of data integration by:
1. Empowering users to capture new relations that integrate disparate data sources “on the fly”. Utilizing a dynamic data model, DiBase™ brings a unique capability to end users to store new integrating relations incrementally as new relations are discovered by various users.
2. Enabling a wide range of field-based expertise to contribute in the growth of the virtual integration layer through a web-based collaborative environment. No matter where or what platform the expert uses, they can still connect and contribute to the growth of the virtual integration layer given they have the correct security access. With DiBase imposing no requirement on a prior design or system understanding, end-users can quickly and easly concentrate on their work and not on the technical challenges of managing the information.
3. Allowing DiBase™ users to create relations based on complex computations separate from the data source. This enables the integration layer to scale not only in size but in complexity as well. DiBase™ embodies a workflow component, FunBase™, which enables users to create and compile complex computation flows with custom functions check-in capability and to store the result into SeBase acting as the integration layer. This enhances the understanding of how or why a relation exists between items in the integration layer. Separating the integration logic from the data layer brings a level of flexibility that takes care of problems when the underlying data source changes.
4. Freeing users from the need to know the underlying data model as a pre-requisite to interacting with the system. In a dynamic environment, users will navigate and discover new relations and access more data without the priory data model understanding. This enhances sharing of new relationships that are discovered and made available by other users.
   Some DiBase Features:
A database model “contextual model” allowing changes to relations among data attributes to be enforced on the fly. It also allows the co-existence of multiple schemas in a database—Schema-base “SeBase”.
Functions affected due to a change in a relationship are displayed for user action.
A new process for propagating access rights to new data, functions, and results
A function-base model “FunBase” for check-in custom functions and storing a dynamically created DFP back in the system for later re-runs or investigation.
A user can establish a new relationship without requiring database redesign.
System notifies a user if a newly created relation violates an existing relationship.

### CONCLUSION

Methods, systems, and articles of manufacture consistent with this invention enable an end-user to dynamically manage all information categories. This includes creating attributes, relations, check-in new functions, and storing results with all details on how they were obtained. Elevating the storing structure in the database model to use context instead of the traditional table as the access structure enables the data model to dynamically store information items on-the-fly. This also frees users from needing design knowledge about the underlying data model to be able to manipulate items in it. Making such a system network accessible, like a web-based system, opens new doors to solving applications, leveraging end-user expertise in areas that were chained down by the technical limitations and resources that surrounded software systems. It also opens the door for true collaboration of all information category items. Users don't only share data or end results, but the way a result was achieved, the method, the path, the data sources used. Collaboration allows users to re-run DFP on their own data to compare result, simply and easily with no more replicating complete system environments. Also, information access is extended. A user can retrieve a result by when it was executed, or who executed, or what functions where used. It changes the way users think of information sharing and how to solve problems.

The above mentioned description of the invention with the variations of implementation has been presented for purposes of illustration and description. It is not exhaustive and does not limit the invention to the precise form disclosed.

For example, the described implementation is a web-based software system, but the present invention could be implemented in a manufacturing factory where a user chooses from a kiosk like machine (i.e hardware) say a paint and a material (i.e. as data sources) to be mixed together to form a shape, as one function, or choose to apply the paint on the surface of a material, as another function with the result being stored tracking the new formulated data-flow-path. This invention may be implemented as software, a combination of software and hardware, or hardware alone. The scope of this invention is defined by the claims and their equivalents.

1. A method for allowing agents to manage on-the-fly relationships among new and existing items from different information categories by storing new relations in a dynamic database model which breaks the link between attributes and relations by using a schema like structure to access and query versus table structures used in static data models while maintaining the data model correctness via an integrity engine comprising:
a. of agents can be end-users, or automated mediums triggered by an internal or external factor, to interact with the different information categories in a collaborative secure environment.
b. Enabling end-users versus technical users to manage on-the-fly items in different information categories by introducing a dynamic integrity engine to check and accept new information items including attributes, relations, functions, stored queries, and results and a user-friendly networked-based access interface best described as a web-based non-technical interface.

2. A method according to claim 1, wherein all information items within the data category are managed by a contextual database model dynamically addressing all database requirement of storage and retrieval of data via a user friendly interface. This model enables schemas to change dynamically, co-existence of multiple schemas, as well as the ability to swiftly integrate with other schemas.

3. A method according to claim 1, wherein backup and restore comprises: selecting within a context some elements as attributes or relations or all elements within that context for backup or restore creating a flat file with an inter-operable format for ease of sharing.

4. A method according to claim 1, wherein all information items are tracked and have security privileges for operations including: read, write, delete, modify, execute, administer, and share permitting collaboration of all information items based on the policies and procedures enforced.

5. A method according to claim 1, wherein all information items within the function category are managed by an open platform function-based model allowing end-users to upload external functions on-the-fly.

6. A method according to claim 1, wherein all information items within the result category is managed in a result-based model with the ability to store results with new items to be stored into the system capturing all result details and meta-data. Result details include: what functions, sequence of functions, version of the sequenced function, input parameters filled in, data sources used as well as meta data like who ran the result, when and how long did it take. This utilizes the contextual data model to store result if of type data, the function-model if result is of type function. This allows the re-execution of DFP and sharing of results for collaboration use and discovery.

7. An apparatus for executing a program, comprising:
A means for receiving user instructions to manipulate items in all information categories on-the-fly while tracking changes and based on security constraints.

8. A process for managing and propagating access to a data category is presented to address the social impact of a single User's freedom to impact change on any data category.

9. A method for multi-User collaboration among different data categorys is disclosed.

10. A method is disclosed for dynamically segmenting a database among multiple hardware platforms with mixed software operating systems on as needed basis. This method allows a single table to be segmented n-number of times and distributed on different database machines. This method could be repeated several times to satisfy performance or scalability needs.

11. A method for utilizing external contextual data for retrieving more accurate user information via function and information categories dynamic selection.
